(19) United States
(12) Patent Application Publication
(10) Pub. No.: US 2025/0330940 A1
(43) Pub. Date: Oct. 23, 2025

(54) POSITIONING MODEL STATISTICS AND CORRESPONDING SETTING SELECTION

(71) Applicant: QUALCOMM Incorporated, San Diego, CA (US)

(72) Inventors: Mohammed Ali Mohammed HIRZALLAH, San Marcos, CA (US); Srinivas YERRAMALLI, San Diego, CA (US); Marwen ZORGUI, San Diego, CA (US)

(21) Appl. No.: 18/639,901

(22) Filed: Apr. 18, 2024

(51) Int. Cl. H04W 64/00; H04W 8/22; H04W 24/10

(52) U.S. Cl. CPC H04W 64/00; H04W 8/22; H04W 24/10

(57) ABSTRACT

A first wireless device, for example a user equipment (UE), a base station, a transmission reception point (TRP), or a location management function (LMF), may transmit a first set of recommended positioning statistics. A second wireless device, for example a UE, a base station, or a TRP, may receive the first set of recommended positioning model statistics. The second wireless device may select a second set of positioning model settings based on the received first set of recommended positioning model statistics. The second wireless device may receive a third set of positioning signals. The second wireless device may measure the third set of positioning signals based on the selected second set of positioning model settings. The second wireless device may calculate a fourth set of positioning outputs using a positioning model based on the measured third set of positioning signals and the selected second set of positioning model settings.

### TECHNICAL FIELD

The present disclosure relates generally to communication systems, and more particularly, to a wireless positioning system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include at least one of a user equipment (UE), a transmission reception point (TRP), or a base station. The apparatus may receive a first set of recommended positioning model statistics. The apparatus may select a second set of positioning model settings based on the received first set of recommended positioning model statistics. The apparatus may receive a third set of positioning signals. The apparatus may measure the third set of positioning signals based on the selected second set of positioning model settings. The apparatus may calculate a fourth set of positioning outputs using a positioning model based on the measured third set of positioning signals and the selected second set of positioning model settings.

In an aspect of the disclosure, a method, a computer-readable medium, and an apparatus are provided. The apparatus may include at least one of a user equipment (UE), a transmission reception point (TRP), a base station, or a location management function (LMF). The apparatus may obtain a plurality of sets of positioning model statistics. The apparatus may transmit a set of recommended positioning model statistics based on the obtained plurality of sets of positioning model statistics.

In some aspects, the techniques described herein relate to a method of wireless communication at a wireless device, including: receiving a first set of recommended positioning model statistics; selecting a second set of positioning model settings based on the received first set of recommended positioning model statistics; receiving a third set of positioning signals; measuring the third set of positioning signals based on the selected second set of positioning model settings; and calculating a fourth set of positioning outputs using a positioning model based on the measured third set of positioning signals and the selected second set of positioning model settings.

In some aspects, the techniques described herein relate to a method, further including: transmitting a positioning report including an indicator of the calculated fourth set of positioning outputs.

In some aspects, the techniques described herein relate to a method, further including: calculating a position of a user equipment (UE) based on the calculated fourth set of positioning outputs.

In some aspects, the techniques described herein relate to a method, further including: transmitting a positioning report including an indicator of the calculated position of the UE.

In some aspects, the techniques described herein relate to a method, wherein the received first set of recommended positioning model statistics include at least one of: a fifth set of bandwidth (BW) settings; a number of transmission reception points (TRPs); a sixth set of TRP identifiers (IDs); a seventh set of positioning model IDs; an eighth set of cell IDs; a ninth set of location indicators; a tenth set of timing indicators; an indicator of a ranking for a set of positioning settings; or an eleventh set of positioning model inputs and a twelfth set of positioning model outputs used on the positioning model.

In some aspects, the techniques described herein relate to a method, wherein the ninth set of location indicators include at least one of: a thirteenth set of indicators associated with a fourteenth set of latitudes; a fifteenth set of indicators associated with a sixteenth set of longitudes; or a seventeenth set of indicators associated with an eighteenth set of elevations.

In some aspects, the techniques described herein relate to a method, further including: selecting a thirteenth set of cells based on the ninth set of location indicators, wherein selecting the second set of positioning model settings based on the received first set of recommended positioning model statistics includes: selecting the second set of positioning model settings based on the selected thirteenth set of cells.

In some aspects, the techniques described herein relate to a method, further including: transmitting a request message including an indicator of a request for the first set of recommended positioning model statistics before the reception of the first set of recommended positioning model statistics.

In some aspects, the techniques described herein relate to a method, further including: receiving a capability message including a second indicator of a capability of a second wireless device to transmit the first set of recommended positioning model statistics, wherein the transmission of the request message is based on the capability of the second wireless device to transmit the first set of recommended positioning model statistics.

In some aspects, the techniques described herein relate to a method, further including: transmitting a second request message including a third indicator of a second request for the capability message before the reception of the capability message.

In some aspects, the techniques described herein relate to a method, further including: selecting the positioning model based on the received first set of recommended positioning model statistics.

In some aspects, the techniques described herein relate to a method, wherein selecting the second set of positioning model settings based on the received first set of recommended positioning model statistics includes: selecting a subset of the first set of recommended positioning model statistics based on a fifth set of measurement selection criteria.

In some aspects, the techniques described herein relate to a method, wherein the fifth set of measurement selection criteria includes at least one of: a delay spread threshold range; a line-of-sight (LOS) peak width; a Rician factor; a number of transmission reception points (TRPs); or a TRP identifier (ID).

In some aspects, the techniques described herein relate to a method, wherein the wireless device includes at least one of a user equipment (UE), a transmission reception point (TRP), or a base station.

In some aspects, the techniques described herein relate to a method of wireless communication at a wireless device, including: obtaining a plurality of sets of positioning model statistics; and transmitting a set of recommended positioning model statistics based on the obtained plurality of sets of positioning model statistics.

In some aspects, the techniques described herein relate to a method, wherein obtaining the plurality of sets of positioning model statistics includes: obtaining a second plurality of sets of positioning signal measurements; calculating a third plurality of sets of positioning outputs using a positioning model based on the second plurality of sets of positioning signal measurements; obtaining a fourth plurality of sets of reliable positioning output data; and calculating the plurality of sets of positioning model statistics based on a comparison of the calculated third plurality of sets of positioning outputs against the fourth plurality of sets of reliable positioning output data.

In some aspects, the techniques described herein relate to a method, wherein obtaining the second plurality of sets of positioning signal measurements includes: receiving a second set of positioning signals and a third set of positioning signals; and measuring the second set of positioning signals and the third set of positioning signals, wherein the second plurality of sets of positioning signal measurements includes the measured second set of positioning signals and the measured third set of positioning signals.

In some aspects, the techniques described herein relate to a method, wherein obtaining the second plurality of sets of positioning signal measurements includes: receiving a second set of positioning signal measurements and a third set of positioning signal measurements, wherein the second plurality of sets of positioning signal measurements includes the measured second set of positioning signals and the measured third set of positioning signals.

In some aspects, the techniques described herein relate to a method, wherein obtaining the fourth plurality of sets of reliable positioning output data includes: calculating a second set of reliable positioning output data based on a third set of positioning sensors, wherein the fourth plurality of sets of reliable positioning output data includes the second set of reliable positioning output data.

In some aspects, the techniques described herein relate to a method, wherein the third set of positioning sensors include at least one of: a global navigation satellite system (GNSS) receiver; a global positioning satellite (GPS) receiver; an accelerometer; or a light detection and ranging (LIDAR) sensor.

In some aspects, the techniques described herein relate to a method, wherein obtaining the fourth plurality of sets of reliable positioning output data includes: calculating a second set of reliable positioning output data based on a second positioning model, wherein the fourth plurality of sets of reliable positioning output data includes the second set of reliable positioning output data.

In some aspects, the techniques described herein relate to a method, wherein obtaining the fourth plurality of sets of reliable positioning output data includes: receiving a second set of reliable positioning output data, wherein the fourth plurality of sets of reliable positioning output data includes the second set of reliable positioning output data.

In some aspects, the techniques described herein relate to a method, wherein calculating the third plurality of sets of positioning outputs using the positioning model based on the second plurality of sets of positioning signal measurements includes: selecting a subset of the second plurality of sets of positioning signal measurements based on measurement selection criteria; and calculating the third plurality of sets of positioning outputs using the positioning model based on the selected subset of the second plurality of sets of positioning signal measurements.

In some aspects, the techniques described herein relate to a method, wherein the measurement selection criteria include at least one of: a delay spread threshold range; a line-of-sight (LOS) peak width; a Rician factor; a number of transmission reception points (TRPs); or a TRP identifier (ID).

In some aspects, the techniques described herein relate to a method, wherein the calculated third plurality of sets of positioning outputs include at least one of: a location of a user equipment (UE); a line-of-sight (LOS) identification metric; timing measurement; or an angle measurement.

In some aspects, the techniques described herein relate to a method, wherein obtaining the plurality of sets of positioning model statistics includes: receiving a second set of positioning model statistics and a third set of positioning model statistics, wherein the plurality of sets of positioning model statistics includes the second set of positioning model statistics and the third set of positioning model statistics.

In some aspects, the techniques described herein relate to a method, further including: selecting the set of recommended positioning model statistics from the plurality of sets of positioning model statistics based on a fourth set of positioning error criteria.

In some aspects, the techniques described herein relate to a method, wherein the fourth set of positioning error criteria include at least one of: a positioning error percentile; an average positioning error range; a positioning error range; a number of positioning occasions; or a recommendation ranking.

In some aspects, the techniques described herein relate to a method, wherein the plurality of sets of positioning model statistics include at least one of: a first indicator of a positioning error percentile; a second indicator of an average positioning error; a third indicator of a positioning error range; or a number of positioning occasions.

In some aspects, the techniques described herein relate to a method, wherein the wireless device includes at least one of a user equipment (UE), a transmission reception point (TRP), a base station, or a location management function (LMF).

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a positioning based on positioning signal measurements.

FIG. 5 is a diagram illustrating an example of positioning based on positioning signal measurements.

FIG. 6A is a diagram illustrating an example of a positioning model (PM) trained using direct positioning labels.

FIG. 6B is a diagram illustrating an example of a PM trained using intermediate positioning labels.

FIG. 7A is a diagram illustrating an example of a wireless device with a PM, where the wireless device is configured to calculate a location of the wireless device using the PM.

FIG. 7B is a diagram illustrating an example of a wireless device with a PM, where the wireless device is configured to calculate an intermediate measurement using the PM.

FIG. 8A is a diagram illustrating an example of a network entity with a PM, where the network entity is configured to calculate a location of the wireless device using the PM.

FIG. 8B is a diagram illustrating an example of a network entity with a PM, where the network entity is configured to calculate a location of the wireless device using the PM.

FIG. 8C is a diagram illustrating an example of a wireless device with a PM, where the wireless device is configured to calculate an intermediate measurement using the PM.

FIG. 9 is a connection flow diagram illustrating an example of a positioning target wireless device and at least one positioning neighbor wireless device configured to store calculated PM statistics.

FIG. 10 is a connection flow diagram illustrating an example of a network entity configured to store calculated PM statistics.

FIG. 11 is another connection flow diagram illustrating an example of a network entity configured to store calculated PM statistics.

FIG. 12 is a connection flow diagram illustrating an example of a positioning target wireless device configured to apply PM settings based on recommended PM statistics.

FIG. 13 is a connection flow diagram illustrating an example of at least one positioning neighbor wireless device configured to apply PM settings based on recommended PM statistics.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

FIG. 18 is a diagram illustrating an example of a hardware implementation for an example network entity.

### DETAILED DESCRIPTION

The following description is directed to examples for the purposes of describing innovative aspects of this disclosure. However, a person having ordinary skill in the art may recognize that the teachings herein may be applied in a multitude of ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless positioning systems. Some aspects more specifically relate to wireless devices configured to provide recommended positioning model (PM) statistics for application of corresponding PM settings. In some examples, a wireless device, such as a user equipment (UE), a transmission reception point (TRP), or a base station, may receive a first set of recommended positioning model statistics. The wireless device may select a second set of positioning model settings based on the received first set of recommended positioning model statistics. The wireless device may receive a third set of positioning signals. The wireless device may measure the third set of positioning signals based on the selected second set of positioning model settings. The wireless device may calculate a fourth set of positioning outputs using a positioning model based on the measured third set of positioning signals and the selected second set of positioning model settings.

In some examples, a wireless device, such as a UE, a TRP, a base station, a set of location servers, or a location management function (LMF) may obtain a plurality of sets of positioning model statistics. The wireless device may transmit a set of recommended positioning model statistics based on the obtained plurality of sets of positioning model statistics.

In some aspects, a wireless device using a positioning model such as an artificial intelligence machine learning (AI/ML) positioning model, may select an optimized positioning approach for a given set of conditions based on associated signaling. In one aspect, for a given area, a first entity may obtain positioning estimates using a plurality of positioning approaches and compare them against positioning information obtained using other positioning techniques to determine the performance statistics of the different positioning approaches under different conditions. The entity may be configured with settings (e.g., positioning approaches to be considered, settings to be considered, area information to be considered, statistics such as targeted K-value and number N of occasions/trials to be considered) by a second entity. In one aspect, a wireless device (e.g., UE or a base station) receives an assistance indicator from a network entity that lists the recommended positioning approach(es) and setting(s) to consider for UE-based/UE-assisted positioning. The wireless device may use the recommended positioning approach and setting(s) to provide positioning information estimate and report it to the network entity. In one aspect, a wireless device (e.g., UE or base station) provides an assistance indicator to a network entity that lists the recommended positioning approach(es) and settings(s) to consider for positioning by a network entity. The network entity may use the recommended positioning approach and setting to obtain positioning information. A network entity may use the recommended positioning approaches and settings in a variety of ways to obtain positioning information. For example, the network entity may configure positioning using a recommended positioning approach and settings, the network entity may aggregate recommended positioning approaches and settings from a variety of positioning entities and may configure positioning using the most commonly recommended positioning approaches and settings (e.g., positioning approaches/settings that have the least amount of error), may organize aggregated recommended positioning approaches and settings into buckets with common attributes (e.g., common cell, common region, common wireless interference attributes) and may configure positioning using the most commonly recommended positioning approaches and settings, or may provide recommended positioning approaches and settings to positioning devices (e.g., UE, base station, TRP). The recommended positioning approaches and settings may be provided as assistance data for use in positioning, or may be provided as information for other positioning devices to parse, aggregate, or organize for additional positioning approaches.

Particular aspects of the subject matter described in this disclosure can be implemented to realize one or more of the following potential advantages. In some examples, by providing recommended positioning model statistics based on collected positioning model data, the described techniques can be used to optimize positioning settings for positioning models in an area based on the monitoring of the performance of different positioning approaches.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

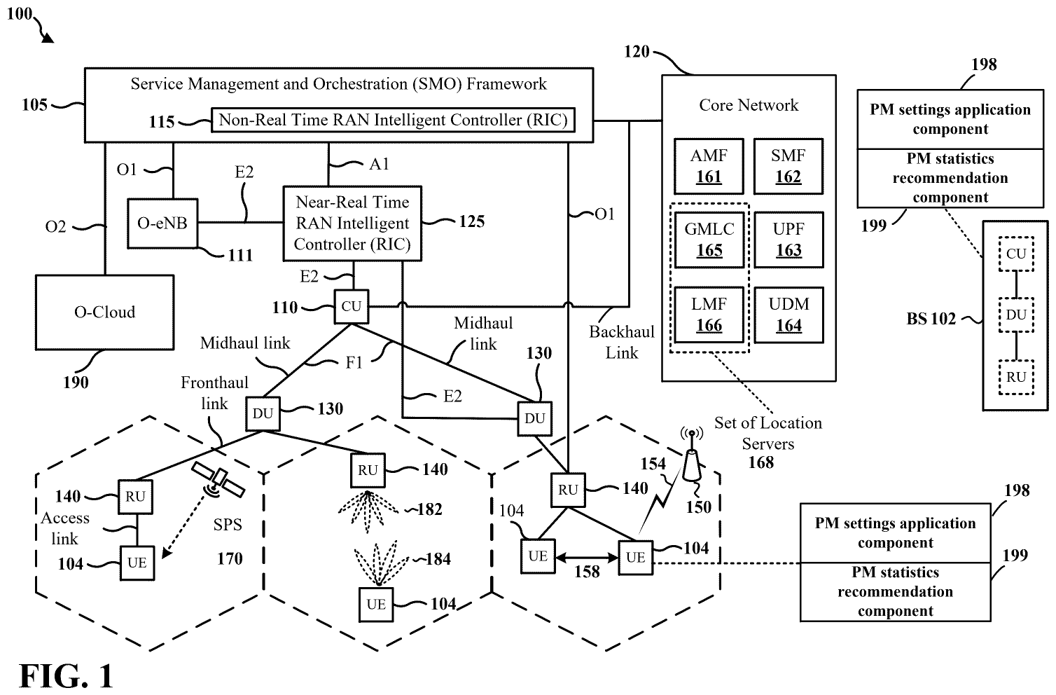

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 and/or the base station 102 may have a positioning model (PM) settings application component 198 that may be configured to receive a first set of recommended positioning model statistics. The PM settings application component 198 may be configured to select a second set of positioning model settings based on the received first set of recommended positioning model statistics. The PM settings application component 198 may be configured to receive a third set of positioning signals. The PM settings application component 198 may be configured to measure the third set of positioning signals based on the selected second set of positioning model settings. The PM settings application component 198 may be configured to calculate a fourth set of positioning outputs using a positioning model based on the measured third set of positioning signals and the selected second set of positioning model settings. In certain aspects, the UE 104, the base station 102, the one or more location servers 168, and/or the LMF 166 may have a PM statistics recommendation component 199 that may be configured to obtain a plurality of sets of positioning model statistics. The PM statistics recommendation component 199 may be configured to transmit a set of recommended positioning model statistics based on the obtained plurality of sets of positioning model statistics.

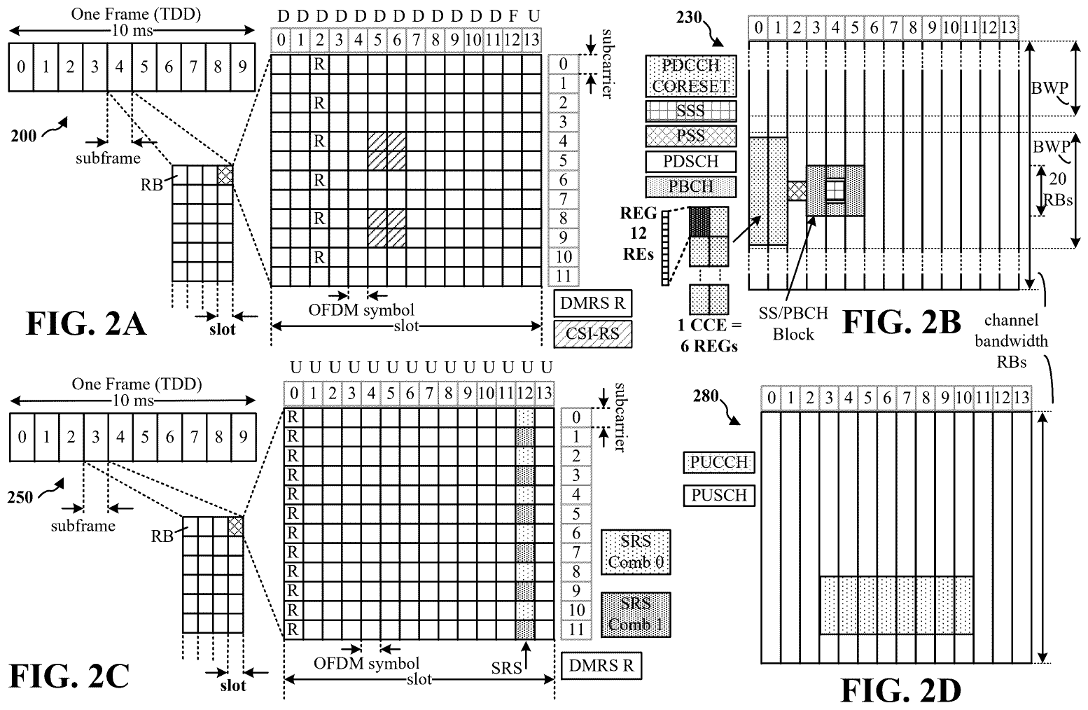

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

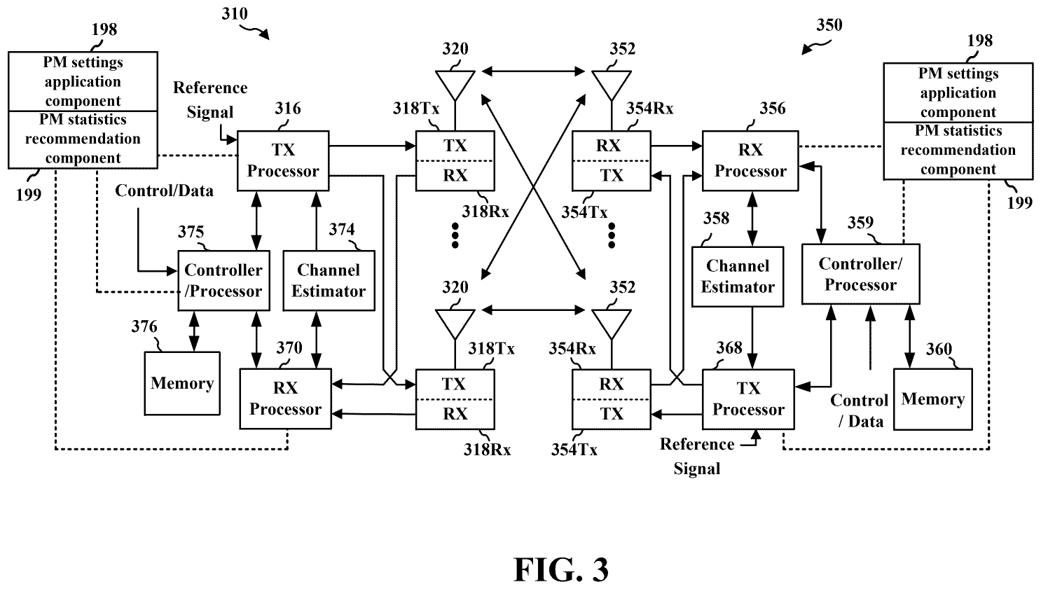

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PM settings application component 198 of FIG. 1.

At least one of the TX processor 368, the RX processor 356, and the controller/processor 359 may be configured to perform aspects in connection with the PM statistics recommendation component 199 of FIG. 1.

At least one of the TX processor 316, the RX processor 370, and the controller/processor 375 may be configured to perform aspects in connection with the PM settings application component 198 of FIG. 1.

At least one of the TX processor 316, the RX processor 370, and the controller/processor 375 may be configured to perform aspects in connection with the PM statistics recommendation component 199 of FIG. 1.

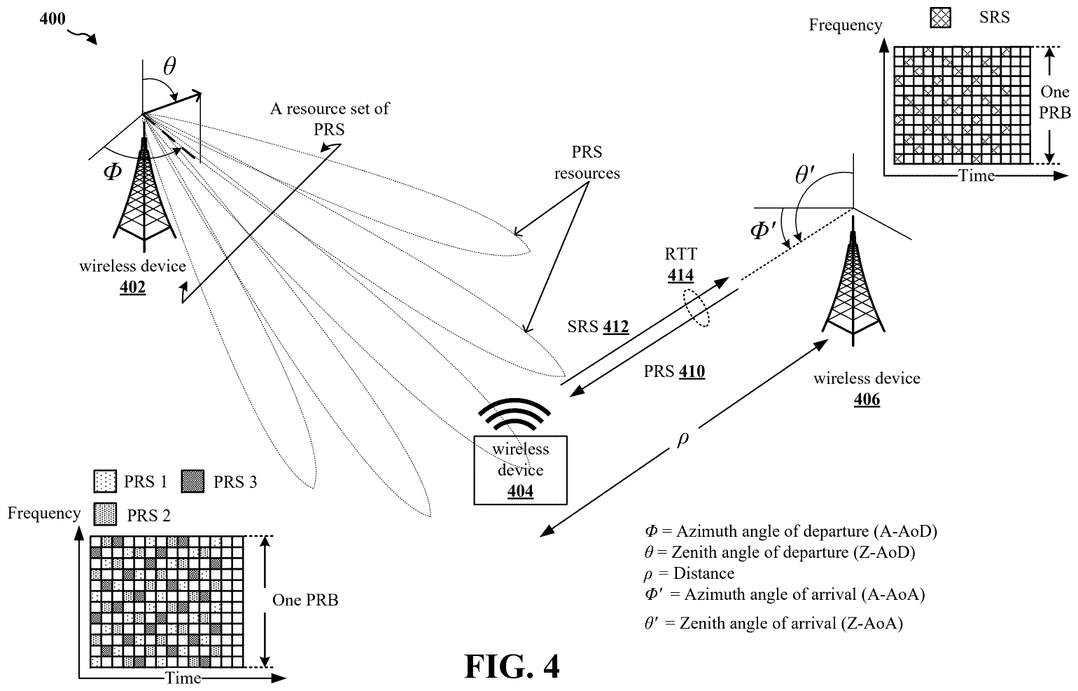

FIG. 4 is a diagram 400 illustrating an example of a positioning based on positioning signal measurements. A positioning signal may be any reference signal which may be measured to calculate a position attribute or a location attribute of a wireless device, for example a positioning reference signal (PRS), a sounding reference signal (SRS), a channel state information (CSI) reference signal (CSI-RS), or a synchronization and signal block (SSB). The wireless device 402 may be a base station, such as a TRP, or a UE with a known position/location, such as a positioning reference unit (PRU) or a UE with a high-accuracy sensor that may identify the location of the UE, for example a GNSS sensor or a GPS sensor. The wireless device 406 may be a base station or a UE with a known position/location. The wireless device 404 may be a UE or a TRP configured to perform positioning to gather data, for example to gather data to train an artificial intelligence machine learning (AI/ML or AIML) model, test positioning signal strength or test positioning noise attributes in an area. The wireless device 404 may transmit UL-SRS 412 at time T_{SRS_TX} and receive DL positioning reference signals (PRS) (DL-PRS) 410 at time T_{PRS_RX}. The wireless device 406 may receive the UL-SRS 412 at time T_{SRS_RX} and transmit the DL-PRS 410 at time T_{PRS_TX}. The wireless device 404 may receive the DL-PRS 410 before transmitting the UL-SRS 412, or may transmit the UL-SRS 412 before receiving the DL-PRS 410. In both cases, a positioning server (e.g., location server(s) 168, LMF 166) or the wireless device 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple wireless devices 402, 406 and measured by the wireless device 404, and the measured TRP Rx-Tx time difference measurements (i.e., |T_{SRS_RX}−T_{PRS_TX}|) and UL-SRS-RSRP at multiple wireless devices 402, 406 of uplink signals transmitted from wireless device 404. The wireless device 404 may measure the UE Rx-Tx time difference measurements (and optionally DL-PRS-RSRP of the received signals) using assistance data received from the positioning server, and the wireless devices 402, 406 may measure the gNB Rx-Tx time difference measurements (and optionally UL-SRS-RSRP of the received signals) using assistance data received from the positioning server. The measurements may be used at the positioning server or the wireless device 404 to determine the RTT. The RTT may be used to estimate the location of the wireless device 404. Other methods are possible for determining the RTT, such as for example using DL-TDOA and/or UL-TDOA measurements.

DL-AoD positioning may make use of the measured DL-PRS-RSRP of downlink signals received from multiple wireless devices 402, 406 at the wireless device 404. The wireless device 404 may measure the DL-PRS-RSRP of the received signals using assistance data received from the positioning server, and the resulting measurements may be used along with the azimuth angle of departure (A-AoD), the zenith angle of departure (Z-AoD), and/or other configuration information to locate the wireless device 404 in relation to the neighboring wireless devices 402, 406.

DL-TDOA positioning may make use of the DL reference signal time difference (RSTD) (and optionally DL-PRS-RSRP) of downlink signals received from multiple wireless devices 402, 406 at the wireless device 404. The wireless device 404 may measure the DL RSTD (and optionally DL-PRS-RSRP) of the received signals using assistance data received from the positioning server, and the resulting measurements may be used along with other configuration information to locate a position/location the wireless device 404 in relation to the neighboring wireless devices 402, 406.

UL-TDOA positioning may make use of the UL relative time of arrival (RTOA) (and optionally UL-SRS-RSRP) at multiple wireless devices 402, 406 of uplink signals transmitted from wireless device 404. The wireless devices 402, 406 may measure the UL-RTOA (and optionally UL-SRS-RSRP) of the received signals using assistance data received from the positioning server, and the resulting measurements may be used along with other configuration information to estimate the location of the wireless device 404.

UL-AoA positioning may make use of the measured azimuth angle of arrival (A-AoA) and zenith angle of arrival (Z-AoA) at multiple wireless devices 402, 406 of uplink signals transmitted from the wireless device 404. The wireless devices 402, 406 may measure the A-AoA and the Z-AoA of the received signals using assistance data received from the positioning server, and the resulting measurements may be used along with other configuration information to estimate the location of the wireless device 404.

Additional positioning methods may be used for estimating the location of the wireless device 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

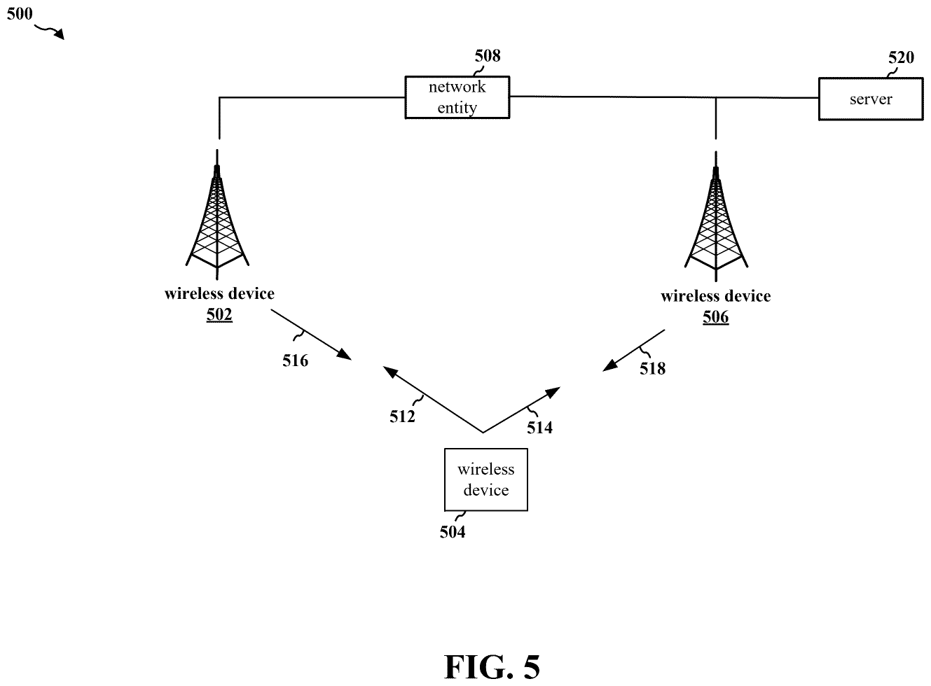

FIG. 5 is a diagram 500 illustrating a network entity 508 that may be configured to coordinate a wireless device 502 and a wireless device 506 to perform positioning with a wireless device 504. The location of the wireless device 502 and the wireless device 506 may be known to at least one of the devices, such as the wireless device 502, the wireless device 504, the wireless device 506, the network entity 508, and/or the server 520. The wireless device 502 may be a base station, a gNB, or a TRP. The wireless device 506 may be a base station, a gNB, or a TRP. The wireless device 504 may be a UE. In some aspects, the UE may be a PRU. A PRU may be a UE with a known location. For example, the PRU may be affixed in a known location or may be placed in a known location for a period of time, or the PRU may have a set of sensors (e.g., high-accuracy GNSS sensor) that may be used to accurately calculate the location of the PRU. In some aspects, the wireless device 504 may be a PRU configured to train a positioning model based on a set of inputs and a set of labels. In some aspects, the wireless device 504 may be a UE configured to use a positioning model to calculate a set of outputs based on a set of inputs, for example measurements of positioning signals. The network entity 508 may be connected to the wireless device 502 and the wireless device 506 via a physical link, for example a backhaul link or a midhaul link, or via a wireless link, such as an air interface (a UE-UTRAN (Uu)) link. The network entity 508 may be part of a core network, such as an LMF or a set of location servers. The network entity 508 may configure positioning occasions between the wireless device 502, the wireless device 504, and the wireless device 506. The server 520 may be an over-the-top (OTT) server or some other server functionally connected to a network that communicates with the network entity 508, the wireless device 502 and/or the wireless device 506, and/or with the wireless device 504 via a wireless device, such as the wireless device 502 and/or the wireless device 506. The server 520 may have storage for storing positioning models, for example AI/ML positioning models, trained using sets of positioning signals received by a wireless device, such as the wireless device 502, the wireless device 504, and/or the wireless device 506.

To perform positioning, the network entity 508 may configure one or more of the wireless devices to transmit positioning signals at one another. For example, the wireless device 504 may transmit the set of positioning signals 512 at the wireless device 502. The set of positioning signals 512 may be a set of SRSs, SSBs, or CSI-RSs. The wireless device 502 may measure the set of positioning signals 512. The wireless device 502 may transmit the set of positioning signals 516 at the wireless device 504. The set of positioning signals 516 may be a set of PRSs, SSBs, or CSI-RSs. The wireless device 504 may measure the set of positioning signals 516. The wireless device 504 may transmit a set of positioning signals 514 at the wireless device 506. The set of positioning signals 514 may be a set of SRSs, SSBs, or CSI-RSs. The wireless device 506 may measure the set of positioning signals 514. The wireless device 506 may transmit a set of positioning signals 518 at the wireless device 504. The set of positioning signals 518 may be a set of PRSs, SSBs, or CSI-RSs. The wireless device 504 may measure the set of positioning signals 518. One or more of the wireless devices may measure the received positioning signals to calculate a positioning measurement that may be used to calculate a position/location of the wireless device 504, or may be used to calculate a position/location of the wireless device 504. For example, if the location of the wireless device 502 and the location of the wireless device 506 are known, the location of the wireless device 504 may be calculated based on a RTT between the wireless device 502 and the wireless device 504, and a RTT between the wireless device 504 and the wireless device 506. In another example, the wireless device 504 may calculate an angle of arrival (AoA) or an angle of departure (AoD) of the set of positioning signals 516, and may calculate an AoA or an AoD of the set of positioning signals 518. The calculated AoAs and/or AoDs may be used to calculate a position of the wireless device 504 if the location of the wireless device 502 and the location of the wireless device 506 are also known. Other measurements, such as RTOA, line-of-sight (LOS) identification (identifying whether there is a direct line-of-sight path between wireless devices), or multi-cell round trip time (multi-RTT) calculations may be performed to calculate the position of the wireless device 504, or to calculate a measurement that may be used to calculate the position of the wireless device 504.

In some aspects, a positioning model may be used to calculate one or more positioning metrics based on the measurements. For example, based on the measurements of the set of positioning signals 512 and/or the set of positioning signals 514 transmitted by the wireless device 504, a position/location of the wireless device 504 may be calculated or estimated, or an intermediate measurement that may be used to calculate the position/location of the wireless device 504 may be calculated or estimated. Such a positioning metric may also be referred to as a positioning output. A positioning model may be trained using artificial intelligence (AI)/machine learning (ML) (AI/ML or AIML), based on a set of inputs (e.g., measurements of positioning signals, assistance information associated with the positioning signals) and a set of labels. A positioning signal may include any reference signal transmitted from a wireless device, such as a PRS, a SRS, an SSB, or a CSI-RS. An RS transmitted from a UE, such as a PRU, may be referred to as an uplink positioning signal, or an UL positioning signal. An RS transmitted from a base station, or TRP, may be referred to as a downlink positioning signal, or a DL positioning signal. A measurement may be a delay profile (DP), a power delay profile (PDP), a channel impulse response (CIR), a channel frequency response (CFR), or other measurement used for performing positioning on a target wireless device. A label may be a calculated, derived, or given (i.e., known) expected result associated with a set of inputs, such as a position/location of a wireless device 504 or an intermediate measurement (e.g., a timing measurement, an angle measurement, a LOS identification) that may be used to calculate the position/location of the wireless device 504. A set of inputs and a set of labels may be used for generating and/or training a positioning model using AI/ML.

When training a positioning model, measurements of positioning signals as inputs, clean or noisy labels (clean labels may have a quality metric greater or equal to a threshold, noisy labels may have a quality metric less than or equal to the threshold) as expected outputs, and training data assistance information as inputs or expected outputs. The positioning model may operate on any wireless device based on a set of inputs. For example, the wireless device 502 may have a positioning model configured to accept a set of positioning measurements and generate an estimate of a position/location of the wireless device 504. In another example, the wireless device 502 may have a positioning model configured to accept a set of positioning measurements and generate an intermediate measurement (e.g., a timing measurement, an angle measurement, a LOS identification) that may be used (by the wireless device 502, or another entity, such as the network entity 508, the wireless device 504, or the wireless device 506) to calculate the position/location of the wireless device 504. In another example, the network entity 508 may have a positioning model configured to accept a set of positioning measurements and generate an estimate of a position/location of the wireless device 504, or generate an intermediate measurement that may be used to calculate the position/location of the wireless device 504. In another example, the wireless device 504 may have a positioning model configured to accept a set of positioning measurements and generate an estimate of a position/location of the wireless device 504, or generate an intermediate measurement that may be used to calculate the position/location of the wireless device 504. In some aspects, the positioning measurements may be aggregated by the entity with the positioning model, for example the network entity 508 may aggregate measurements of the set of positioning signals 512 from the wireless device 502, measurements of the set of positioning signals 514 the wireless device 506 to use as inputs to a positioning model, measurements of the set of positioning signals 516 from the wireless device 504, and/or measurements of the set of positioning signals 518 from the wireless device 504.

A positioning model may be trained on a wireless device that performs positioning, such as the wireless device 502, the wireless device 504, the wireless device 506, the network entity 508, and/or the server 520. The inputs to the positioning model may include measurements of positioning signals, such as measurements of SRS, PRS, SSB, and/or CSI-RS. The inputs to the measurements may include assistance information associated with the measured positioning signals, such as BWP of a positioning signal resource, number of TRPs, beam information, positioning signal configuration). The labels/outputs for the positioning model may include a location, or an intermediate measurement. In one aspect, the server 520 may be an OTT server configured to train and store positioning models. In another aspect, the network entity 508 may be configured to train and store positioning models. In other words, the server 520 or the network entity 508 may be a training entity configured to train positioning models based on input measurements taken by a wireless device, such as the wireless device 502, the wireless device 504, and/or the wireless device 506, and based on labels either known (e.g., stored on memory) or calculated by at least one of the wireless device 502, the wireless device 504, the wireless device 506, and/or the network entity 508. A positioning model may be configured to calculate a set of outputs. The set of outputs may include, for example, position of a wireless device, a reference signal time difference (RSTD), a line of sight (LOS) indicator (e.g., whether there exists a direct line-of-sight path between wireless devices, the likelihood of whether there exists a direct line-of-sight path between wireless devices), a multipath timing indicator (e.g., a time of flight per path, a time of arrival per path with respect to a timing mark), a multipath power indicator (e.g., strength of a signal per path), a multipath phase indicator (e.g., phase of a signal per path), a reference signal received power (RSRP), and/or an angle of departure (AoD).

In some aspects, a positioning model may be configured to use measurements of positioning signals transmitted from a wireless device to calculate a position of the wireless device 504, or to calculate an intermediate measurement that may be used to calculate the position of the wireless device 504. The positioning model may be trained via a training entity, and may be used at the wireless device 502, at the wireless device 504, at the wireless device 506, or at the network entity 508. For example, a positioning model at the wireless device 504 may be configured to calculate the location of the wireless device 504 based on measurements of the set of positioning signals 516 and/or the set of positioning signals 518. In another example, the wireless device 502 may transmit a set of intermediate measurements to the network entity 508 so that the network entity 508 may calculate the location of the wireless device 504 based on the set of intermediate measurements. In another example, the wireless device 504 may transmit measurements of the set of positioning signals 516 and/or the set of positioning signals 518 to the network entity 508. The positioning model may be at the network entity 508. The positioning model at the network entity 508 may calculate the location of the wireless device 504 based on the transmitted measurements of the set of positioning signals 516 and/or the set of positioning signals 518 from the wireless device 504, the transmitted measurements of the set of positioning signals 512 from the wireless device 502, and/or the transmitted measurements of the set of positioning signals 514 from the wireless device 506. In other words, any of the wireless device 502, the wireless device 504, and/or the wireless device 506 may assist the network entity 508 in performing positioning using a trained positioning model.

In some aspects, a positioning model may be site-specific. For example, a first positioning model may be trained in a location, or a set of locations, associated with a first site having a first set of borders, and a second positioning model may be trained in a location, or a set of locations, associated with a second site having a second set of borders. A wireless device may be configured to use one of a plurality of site-specific positioning models. For example, the wireless device may select a site-specific positioning model based on its location, or may select a site-specific positioning model based on an indicator, for example a signal transmitted from the network entity 508 that indicates that a particular site-specific positioning model from a plurality of site-specific positioning models be selected.

Measurements of positioning signals may be performed by measuring channels between a target device (e.g., the wireless device 504) and a set of network nodes (e.g., the wireless device 502 and the wireless device 506). The wireless device 504 may transmit a positioning signal, such as an SRS, an SSB, or a CSI-RS. The wireless device 502 and/or the wireless device 506 may measure the positioning signal for data collection purposes to train a positioning model. The wireless device 504 and/or the wireless device 506 may transmit a positioning signal, such as a PRS, an SSB, or a CSI-RS. The wireless device 504 may measure the positioning signal for data collection purposes to train the positioning model. The wireless device 502, the wireless device 504, and/or the wireless device 506 may measure a positioning signal resource in a plurality of ways, for example the measurement may be a channel impulse response (CIR), a channel frequency response (CFR), a power delay profile (PDP), a delay profile (DP), a set of reflection paths, a reception-transmission (Rx-Tx) time difference, a received signal strength indicator (RSSI), a reference signal received power (RSRP), a reference signal received power per path (RSRPP), a reference signal received quality (RSRQ), a time of arrival (ToA), a time of departure (ToD), a reference signal time difference (RSTD), an angle of arrival (AoA), and/or an angle of departure (AoD).

While the diagram 500 illustrates two positioning neighbor wireless devices, wireless device 502 and wireless device 506, configured to perform positioning with one positioning target wireless device, wireless device 504, to calculate a position/location of the wireless device 504, any number of positioning neighbor wireless devices may be configured to perform positioning with any number of positioning target wireless devices. For example, four positioning neighbor wireless devices may be configured to calculate the position/location of two positioning target wireless devices, three positioning neighbor wireless devices may be configured to calculate the position/location of one positioning target wireless device, or two positioning neighbor wireless devices may be configured to calculate the position/location of one positioning target wireless device.

A measurement of a positioning signal (PRS, SRS, SSB) may include a channel frequency response (CFR) measurement, a channel impulse response (CIR) measurement, a power delay profile (PDP) measurement, or a delay profile (DP) measurement. A wireless device may measure a CFR by applying channel estimation in a frequency domain based on a positioning signal sequence (e.g., a PRS sequence, an SRS sequence) mapped to a set of OFDM signals. The wireless device may measure a CIR based on a CFR, for example by applying an inverse fast Fourier transform (IFFT) to the CFR (i.e., CIR=IFFT (CFR)). The wireless device may calculate a CIR as the largest measurement size, where the CIR includes a list of measurements where each measurement contains the information of a delay, power, and phase of a positioning signal. The wireless device may subsample a CIR by applying truncation to such a CIR. The CIR may also correspond with a set of time, power/magnitude, and/or phase information that are derived from the output of an IFFT of the CFR. The wireless device may measure a PDP be calculating the absolute value of a CIR (i.e., abs (CIR)) at a particular measurement point. The wireless device may calculate a PDP by correlating a plurality of time and power information derived from the CIR. The wireless device may calculate a PDP as a smaller measurement size than the CIR, where the PDP includes a list of measurements where each measurement contains the information of a delay and power of a positioning signal. The wireless device may subsample a PDP by applying truncation to the PDP. The wireless device may calculate a DP by correlating timing information of CIR or PDP measurements with the significant power information or peak information. The wireless device may calculate a DP by correlating a plurality of timing information derived from a CIR or PDP. In some aspects, the wireless device may calculate a DP by degenerating the PDP (e.g., the timing representation of the PDP). The wireless device may calculate a DP as a smallest measurement size, where the DP includes a list of measurements where each measurement contains the information of a delay. The wireless device may subsample a DP by applying truncation to the DP.

In some aspects, a positioning model may be trained using subsampled measurements, for example truncated measurements, specific values of samples (e.g., local maximum values, local minimum values), or samples associated with specified paths (e.g., first received path, direct LOS path). A wireless device that measures positioning signals (e.g., a CIR, PDP, or DP measurement of a PRS, SRS, or SSB) may use a predefined methodology to subsample measurements to use for a positioning model. The subsampled measurements may be used to train a positioning model along with a set of labels, or may be used to calculate positioning outputs using a trained positioning model. In some aspects, where the positioning model is not on a wireless device that receives and measures positioning signals (e.g., at the network entity 508, at the server 520), wireless resources may be conserved by transmitting subsampled measurements to the entity with the positioning model. The wireless device receiving positioning signals may subsample a measurement (e.g., CIR/PDP/DP) of a positioning signal (e.g., PRS, SRS, SSB) using a subsampling configuration to select a subset of the measurements to report. A wireless device, for example the wireless device 502, the wireless device 504, or the wireless device 506, may report subsampled measurements of a positioning signal using a predefined methodology, for example by selecting a subset of specific measurements, measurements associated with a subset of samples, or measurements associated with a subset of paths, for reporting to the device with the positioning model (e.g., the network entity 508, the server 520). The network entity 508 may exchange control signals with such a wireless device to ensure that subsampling is aligned between the wireless device and the device with the positioning model.

In some aspects, the wireless device may keep a plurality of subsampling configurations in device memory at a time if the subsampling configurations are frequently activated (e.g., at least once every ten minutes), allowing the wireless device to dynamically switch between subsampling configurations kept in device memory. The wireless device may be configured to activate a plurality of positioning models activated (e.g., loaded in memory and ready to use to calculate a positioning output based on input measurements), where each of the plurality of positioning models corresponds with a different subsampling configuration. In some aspects, the plurality of positioning models may consider different periodicity (e.g., alternating) of their measurement occasions to provide different positioning accuracy. In such aspects, the positioning models may appear to be running simultaneously, even if they may be utilized in an alternating fashion. For example, a positioning model with high complexity (e.g., larger processing time) may be configured to accept a first subsampling configuration running on a longer repetition of measurement occasion (e.g., every 4 measurement occasions) when compared to a positioning model with a lower complexity (e.g., lower processing time) running on a shorter repetition of measurement occasion (e.g., 3 measurement occasions in a row, then skipping one measurement occasion). The positioning model with higher complexity be more accurate than the positioning model with lower complexity, and may bolster the calculations of the positioning model with lower complexity.

In some aspects, the network entity 508 may be configured to activate a subsampling method at a wireless device (e.g., the wireless device 502, the wireless device 504, or the wireless device 506) via a command issued from the network entity 508 to the wireless device. The wireless device may calculate a subsample of a set of measurements based on the activated method and report the subsampled measurements to the network entity 508. In some aspects, a wireless device may be configured to autonomously select a configured method. The network entity 508 may provide a variety of configured methods to the wireless device, or a set of positioning models associated with the configured methods (e.g., a set of positioning model IDs that have been trained using the configured methods). The wireless device may calculate a subsample of a set of measurements based on the activated method and report the subsampled measurements to the network entity 508 along with an indicator of the autonomously selected configured method.

As used herein, a subsample may include a selected path of a set of paths received by the wireless device or a selected sample of a set of samples received by the wireless device. A sample may refer to a signal processing entity that is correlated with a set of timing information, power/magnitude information, and phase information. A path may refer to a geometrical description of a signal trajectory from a transmitting device to a receiving device. A path may also be correlated with a set of timing information, power/magnitude information, and phase information. A subsample may correspond with a path. A subsample may be used to describe a path. A wireless device may process a set of samples to obtain timing, power/magnitude, and phase information associated with a path. For example, a wireless device may apply interpolation between samples to obtain timing, power/magnitude, and phase information associated with a path. In another example, a wireless device may apply a super resolution method (e.g., multiple signal classification (MUSIC) or matrix pencil) to obtain timing, power/magnitude, and phase information associated with a path.

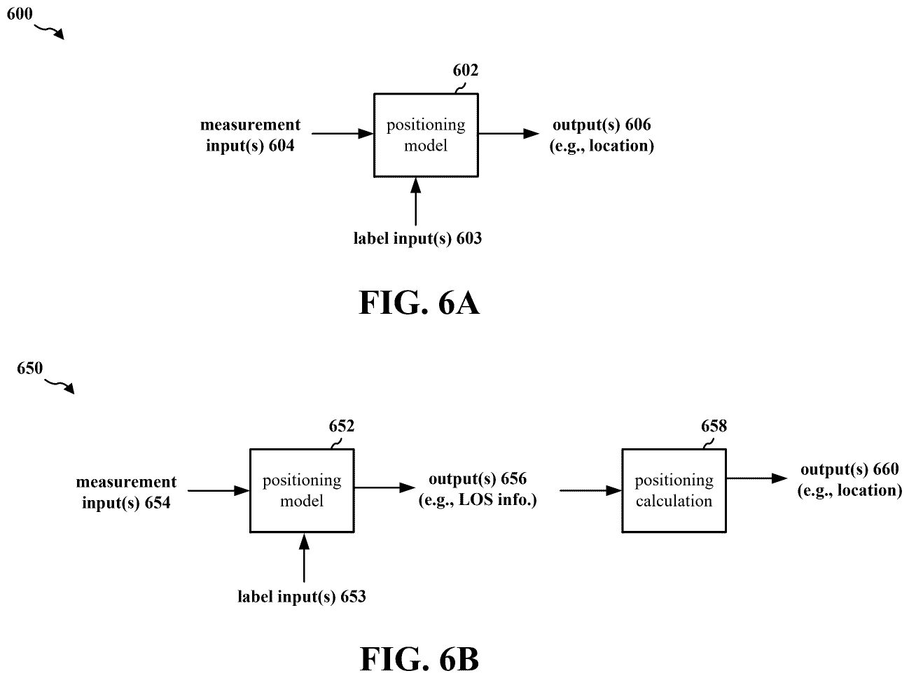

FIG. 6A is a diagram 600 illustrating an example of a positioning model 602. The positioning model 602 may be trained using direct positioning labels. For example, the positioning model 602 may be trained using a set of measurement inputs 604 and a set of label inputs 603. The set of measurement inputs 604 may include, for example, a set of measurements of SRS positioning signals, a set of measurements of PRS positioning signals, and/or a set of measurements of SSB positioning signals. The measurements may include a CFR, a CIR, a PDP, and/or a DP. The set of label inputs 603 may include, for example, a location of a wireless device, for example a PRU/UE with a known location, or a sensor that can accurately calculate the location of the wireless device (e.g., a GPS sensor, a camera). The positioning model 602 may be trained using AI/ML techniques to calculate the set of label inputs 603 based on the set of measurement inputs 604.

Once the positioning model 602 is trained, the positioning model 602 may be used to calculate a set of outputs 606 based on the set of measurement inputs 604. The set of outputs 606 may include an estimate of the location of a wireless device that received and measured a set of positioning signals, or that transmitted a set of positioning signals for measuring at another wireless device. The positioning model 602 may be referred to as a direct positioning model that directly calculates a location of a wireless device. In some aspects, the positioning model 602 may be trained using AI/ML techniques, in which case the positioning model 602 may be referred to as a direct AI/ML positioning model.

FIG. 6B is a diagram 650 illustrating an example of a positioning model 652. The positioning model 652 may be trained using intermediate measurement labels. Intermediate measurements may be measurements that may be used to calculate a location of a wireless device. For example, the positioning model 652 may be trained using a set of inputs 654 and a set of labels 653. The set of inputs 654 may include, for example, a set of measurements of SRS positioning signals, a set of measurements of PRS positioning signals, and/or a set of measurements of SSB positioning signals. The measurements may include a CFR, a CIR, a PDP, and/or a DP. The set of labels 653 may include, for example, a set of timing measurements (e.g., ToA, ToD), a set of angle measurements (e.g., AoA, AoD), or a line-of-sight (LOS) identification (e.g., a probability that there exists a direct line of sight between a wireless device that transmits a positioning signal and a wireless device that receives a positioning signal). The set of labels 653 may be obtained by known environmental conditions, for example a training entity may know that there exists a barrier that blocks a direct LOS between two wireless devices, or a training entity may know the AoD of a positioning signal that is transmitted from a wireless device. The wireless device may be a PRU/UE in a known environment where intermediate measurements are known. The positioning model 652 may be trained using AI/ML techniques to calculate the set of labels 653 based on the set of inputs 654.

Once the positioning model 652 is trained, the positioning model 652 may be used to calculate a set of outputs 656 based on the set of inputs 654. The set of outputs 656 may include an intermediate measurement that may be used to calculate a location of a wireless device associated with the intermediate measurement (e.g., the wireless device may transmit or receive a positioning signal associated with the intermediate measurement). A device may then use the set of outputs 656 to calculate a location of a wireless device, for example by feeding the set of outputs 656 into a positioning calculation 658 to calculate a set of outputs 660. The positioning calculation 658 may include, for example, a non-AI algorithm (e.g., a Chan algorithm, a Kalman Filter (KF)), or an AI positioning model that is trained using a set of intermediate measurements and a known location of a wireless device. The wireless device used to train the positioning model 652 may be a different wireless device used to train the positioning calculation 658. The positioning model 652 may be referred to as an indirect positioning model that indirectly calculates a location of a wireless device by providing intermediate measurements that may be used by another technique, or another device, to calculate the location of a wireless device. In some aspects, the positioning model 652 may be trained using AI/ML techniques, in which case the positioning model 652 may be referred to as an indirect AI/ML positioning model.

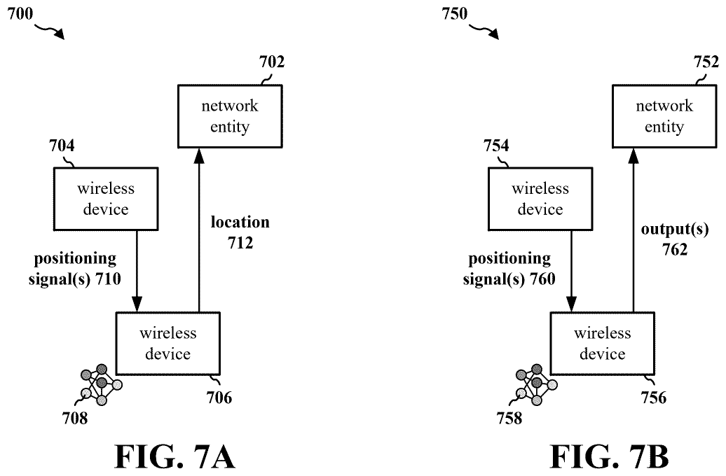

FIG. 7A is a diagram 700 illustrating an example of a wireless device 706 with a positioning model 708. The wireless device 706 may store the positioning model 708 on a local memory of the wireless device 706, or may access the positioning model 708 on an accessible device, for example a cloud server or an over the top (OTT) server. The positioning model 708 may include a direct positioning model used to calculate the location of the wireless device 706, or may include an indirect positioning model used to calculate an intermediate measurement associated with the wireless device 706, which the wireless device 706 may use to calculate its location (e.g., using a KF or a direct positioning model). The wireless device 706 may include a UE or a PRU used to train the positioning model 708 or to use the positioning model 708 to calculate the location of the wireless device 706.

The wireless device 704 may be a device that transmits positioning signals, for example a network node, a UE, a PRU, a base station, or a TRP. The network entity 702 may include a core network device, an LMF, or a set of location servers. The wireless device 704 may transmit a set of positioning signals 710. The wireless device 706 may receive the set of positioning signals 710 transmitted by the wireless device 704. The positioning signals 710 may include a set of PRSs or a set of SSBs. The wireless device 706 may measure the set of positioning signals 710 and may input the measurements of the positioning signals 710 into the positioning model 708, for example to train the positioning model 708, to calculate the location of the wireless device 706, or to calculate an intermediate measurement that may be used by the wireless device 706 to calculate the location of the wireless device 706. The wireless device 706 may transmit an indication of a location 712 to a network entity 702. The network entity 702 may receive the indication of the location 712 from the wireless device 706. The network entity 702 may determine the location of the wireless device 706 based on the indication of the location 712.

FIG. 7B is a diagram 750 illustrating an example of a wireless device 756 with a positioning model 758. The wireless device 756 may store the positioning model 758 on a local memory of the wireless device 756, or may access the positioning model 758 on an accessible device, for example a cloud server or an OTT server. The positioning model 758 may include an indirect positioning model used to calculate an intermediate measurement associated with the wireless device 756, which the network entity 752 may use to calculate the location of the wireless device 756 (e.g., using a KF or a direct positioning model). The wireless device 756 may include a UE or a PRU used to train the positioning model 758 or to use the positioning model 758 to calculate an intermediate measurement associated with the wireless device 756.

The wireless device 754 may be a device that transmits positioning signals, for example a network node, a UE, a PRU, a base station, or a TRP. The network entity 752 may include a core network device, an LMF, or a set of location servers. The wireless device 754 may transmit a set of positioning signals 760. The wireless device 756 may receive the set of positioning signals 760 transmitted by the wireless device 754. The positioning signals 760 may include a set of PRSs or a set of SSBs. The wireless device 756 may measure the set of positioning signals 760 and may input the measurements of the positioning signals 760 into the positioning model 758, for example to train the positioning model 758 or to calculate an intermediate measurement that may be used by the network entity 752 to calculate the location of the wireless device 756. The wireless device 756 may transmit an indication of the set of outputs 762 calculated by the positioning model 758 to a network entity 752. The network entity 752 may receive the indication of the set of outputs 762 from the wireless device 756. The network entity 752 may calculate the location of the wireless device 756 based on the indication of the set of outputs 762, for example by feeding the set of outputs 762 into an algorithm (e.g., a Chan algorithm, a KF) or a direct positioning model. In some aspects, the network entity 752 may calculate the location of the wireless device 756 based on a plurality of measurements received by a plurality of wireless devices. For example, the wireless device 754 may receive a set of positioning signals from the wireless device 756, may measure the set of positioning signals, and may transmit the measurements to the network entity 752 for the calculation of the location of the wireless device 756. The measurements may include, for example, intermediate measurements calculated using another indirect positioning model, or may include direct measurements of the positioning signals. In another example, the wireless device 756 may transmit the measurements of the set of positioning signals 760 to the network entity 752 in addition to the set of outputs from the positioning model 758.

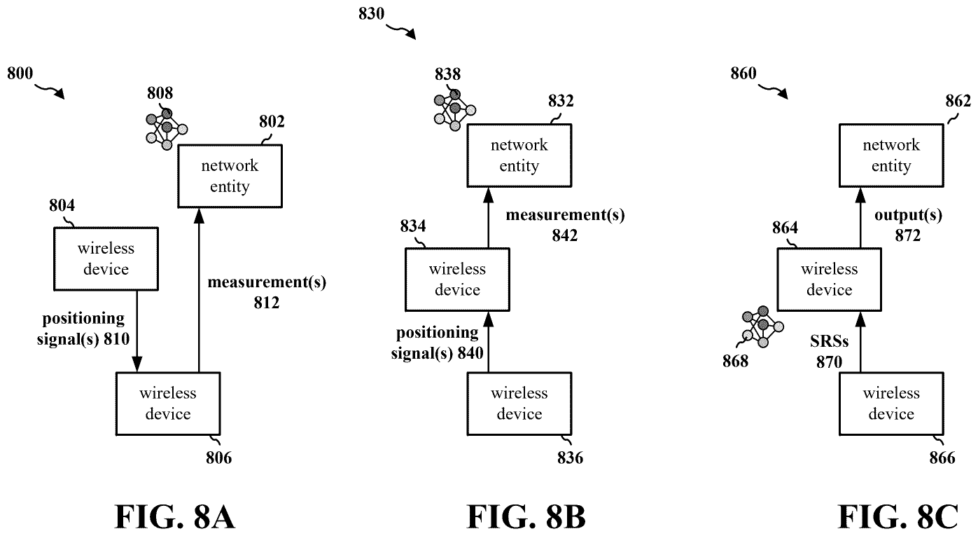

FIG. 8A is a diagram 800 illustrating an example of a network entity 802 with a positioning model 808. The network entity 802 may store the positioning model 808 on a local memory of the network entity 802, or may access the positioning model 808 on an accessible device, for example a cloud server or an OTT server. The positioning model 808 may include a direct positioning model used to calculate the location of the wireless device 806, or may include an indirect positioning model used to calculate an intermediate measurement associated with the wireless device 806, which the network entity 802 may use to calculate the location of the wireless device 806 (e.g., using a KF or a direct positioning model). The network entity 802 may include a core network device, such as an LMF or a set of location servers, or may include a server, for example an OTT server, used to train the positioning model 808 or to use the positioning model 808 to calculate the location of the wireless device 806.

The wireless device 804 may be a device that transmits positioning signals, for example a network node, a UE, a PRU, a base station, or a TRP. The wireless device 806 may be a device that receives and measures positioning signals, for example a network node, a UE, a PRU, a base station, or a TRP. The wireless device 804 may transmit a set of positioning signals 810. The wireless device 806 may receive the set of positioning signals 810 transmitted by the wireless device 804. The positioning signals 810 may include a set of PRSs or a set of SSBs. The wireless device 806 may measure the set of positioning signals 810 and may transmit an indication of the set of measurements 812 (e.g., an indication of a CFR, CIR, PDP, or DP) to the network entity 802. The network entity 802 may input a representation of the indication of the set of measurements 812 into the positioning model 808, for example to train the positioning model 808, to calculate the location of the wireless device 806, or to calculate an intermediate measurement that may be used by the wireless device 806 to calculate the location of the wireless device 806. The network entity 802 may determine the location of the wireless device 806 based on the calculation by the positioning model 808. In some aspects, the network entity 802 may collect a set of measurements from a plurality of devices to input into the positioning model 808. For example, the wireless device 804 may receive a set of positioning signals (e.g., a set of SSBs, a set of SRSs) from the wireless device 806, may measure the set of positioning signals, and may transmit the measurements to the network entity 802, which the network entity 802 may use to calculate the location of the wireless device 806, or may use as an input into the positioning model 808.

FIG. 8B is a diagram 830 illustrating an example of a network entity 832 with a positioning model 838. The network entity 832 may store the positioning model 838 on a local memory of the network entity 832, or may access the positioning model 838 on an accessible device, for example a cloud server or an OTT server. The positioning model 838 may include a direct positioning model used to calculate the location of the wireless device 836, or may include an indirect positioning model used to calculate an intermediate measurement associated with the wireless device 836, which the network entity 832 may use to calculate the location of the wireless device 836 (e.g., using a KF or a direct positioning model). The network entity 832 may include a core network device, such as an LMF or a set of location servers, or may include a server, for example an OTT server, used to train the positioning model 838 or to use the positioning model 838 to calculate the location of the wireless device 836.

The wireless device 836 may be a device that transmits positioning signals, for example a network node, a UE, a PRU, a base station, or a TRP. The wireless device 834 may be a device that receives and measures positioning signals, for example a network node, a UE, a PRU, a base station, or a TRP. The wireless device 836 may transmit a set of positioning signals 840. The wireless device 834 may receive the set of positioning signals 840 transmitted by the wireless device 836. The positioning signals 840 may include a set of SRSs or a set of SSBs. The wireless device 834 may measure the set of positioning signals 840 and may transmit an indication of the set of measurements 842 (e.g., an indication of a CFR, CIR, PDP, or DP) to the network entity 832. The network entity 832 may input a representation of the indication of the set of measurements 842 into the positioning model 838, for example to train the positioning model 838, to calculate the location of the wireless device 836, or to calculate an intermediate measurement that may be used by the wireless device 836 to calculate the location of the wireless device 836. The network entity 832 may determine the location of the wireless device 836 based on the calculation by the positioning model 838. In some aspects, the network entity 832 may collect a set of measurements from a plurality of devices to input into the positioning model 838. For example, the wireless device 836 may receive a set of positioning signals (e.g., a set of SSBs, a set of PRSs) from the wireless device 834, may measure the set of positioning signals, and may transmit the measurements to the network entity 832, which the network entity 832 may use to calculate the location of the wireless device 836, or may use as an input into the positioning model 838.

FIG. 8C is a diagram 860 illustrating an example of a wireless device 864 with a positioning model 868. The wireless device 864 may store the positioning model 868 on a local memory of the wireless device 864, or may access the positioning model 868 on an accessible device, for example a cloud server or an OTT server. The positioning model 868 may include an indirect positioning model used to calculate an intermediate measurement associated with the wireless device 866, which the network entity 862 may use to calculate the location of the wireless device 866 (e.g., using a KF or a direct positioning model). The wireless device 864 may include a base station, a network node, or a TRP used to train the positioning model 868 or to use the positioning model 868 to calculate an intermediate measurement associated with the wireless device 866.

The wireless device 866 may be a device that transmits positioning signals, for example a network node, a UE, a PRU, a base station, or a TRP. The network entity 862 may include a core network device, an LMF, or a set of location servers. The wireless device 866 may transmit a set of positioning signals 870. The wireless device 864 may receive the set of positioning signals 870 transmitted by the wireless device 866. The positioning signals 870 may include a set of SRSs or a set of SSBs. The wireless device 864 may measure the set of positioning signals 870 and may input the measurements of the positioning signals 870 into the positioning model 868, for example to train the positioning model 868 or to calculate an intermediate measurement that may be used by the network entity 862 to calculate the location of the wireless device 866. The wireless device 864 may transmit an indication of the set of outputs 872 calculated by the positioning model 868 to a network entity 862. The network entity 862 may receive the indication of the set of outputs 872 from the wireless device 864. The network entity 862 may calculate the location of the wireless device 866 based on the indication of the set of outputs 872, for example by feeding the set of outputs 872 into an algorithm (e.g., a Chan algorithm, a KF) or a direct positioning model. In some aspects, the network entity 862 may calculate the location of the wireless device 866 based on a plurality of measurements received by a plurality of wireless devices. For example, the wireless device 866 may receive a set of positioning signals (e.g., PRSs, SSBs) from the wireless device 864, may measure the set of positioning signals, and may transmit the measurements to the network entity 862 for the calculation of the location of the wireless device 866. The measurements may include, for example, intermediate measurements calculated using another indirect positioning model, or may include direct measurements of the positioning signals. In another example, the wireless device 864 may transmit the measurements of the set of positioning signals 870 to the network entity 862 in addition to the set of outputs from the positioning model 868.

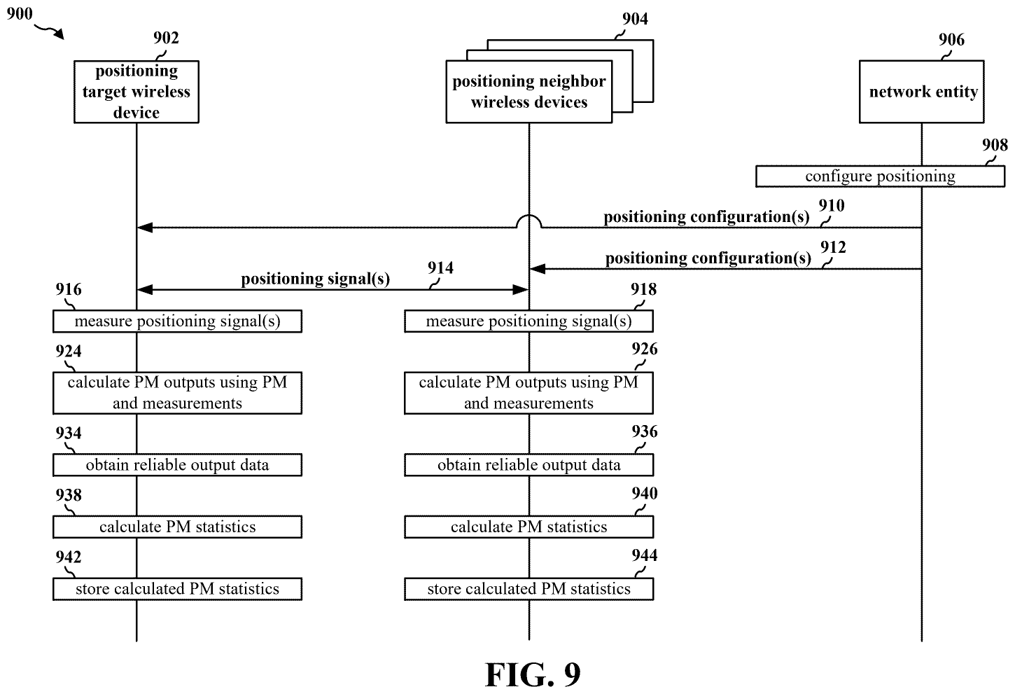

FIG. 9 is a connection flow diagram 900 illustrating an example of a positioning target wireless device 902 and at least one of the set of positioning neighbor wireless devices 904 configured to store calculated PM statistics based on usage of a positioning model. The network entity 906 may be configured to configure positioning for a set of positioning signals (e.g., SRS, PRS, SSB) measured by a wireless device, such as the positioning target wireless device 902 or the set of positioning neighbor wireless devices 904. The positioning target wireless device 902 may be a UE or a PRU. The set of positioning neighbor wireless devices 904 may include a set of base stations and/or a set of TRPs. The network entity 906 may include an LMF or a set of location servers.

AT 908 the network entity 906 may configure positioning for the positioning target wireless device 902 and the set of positioning neighbor wireless devices 904. The configuration may include a configuration for the set of positioning neighbor wireless devices 904 to transmit a set of positioning signals 914 at the positioning target wireless device 902, and for the positioning target wireless device 902 to measure the set of positioning signals 914 received from the set of positioning neighbor wireless devices 904 for a set of positioning models. The configuration may include a configuration for the positioning target wireless device 902 to transmit a set of positioning signals 914 at the set of positioning neighbor wireless devices 904, and for the set of positioning neighbor wireless devices 904 to measure the set of positioning signals 914 received from the positioning target wireless device 902 for a set of positioning models.

The network entity 906 may transmit a set of positioning configurations 910 at the positioning target wireless device 902. The positioning target wireless device 902 may receive the set of positioning configurations 910 from the network entity 906. The network entity may transmit a set of positioning configurations 912 at the set of positioning neighbor wireless devices 904. The set of positioning neighbor wireless devices 904 may receive the set of positioning configurations 912 from the network entity 906. The set of positioning neighbor wireless devices 904 may transmit the positioning signals 914 at the positioning target wireless device 902 based on the set of positioning configurations 912 received from the network entity 906. The set of positioning signals 914 may include a set of positioning RSs, for example PRSs, and/or SSBs. The positioning target wireless device 902 may transmit the positioning signals 914 at the set of positioning neighbor wireless devices 904 based on the set of positioning configurations 910 received from the network entity 906. The set of positioning signals 914 may include a set of positioning RSs, for example SRSs, and/or SSBs.

At 916, the positioning target wireless device 902 may measure the set of positioning signals 914 received from the set of positioning neighbor wireless devices 904. At 924, the positioning target wireless device 902 may calculate a set of positioning model outputs using a set of positioning models based on the measurements taken at 916. At 934, the positioning target wireless device 902 may obtain reliable output data. For example, the location of the positioning target wireless device 902 may be known (e.g., the positioning target wireless device 902 may be a PRU with a known location), and a user may input the known location to the positioning target wireless device 902. In another example, an intermediate measurement associated with the positioning target wireless device 902 may be known (e.g., LOS data may be known, an AoA/AoD of a beam may be known), and a user may input the known location to the positioning target wireless device 902. In another example, a reliable sensor (e.g., GNSS, GPS, LIDAR) may be used to calculate the position of the positioning target wireless device 902. In another example, a reliable positioning method or algorithm (e.g., an RTT calculation) may be used to calculate the position of the positioning target wireless device 902.

At 938, the positioning target wireless device 902 may calculate positioning model statistics based on a comparison of the calculated positioning model outputs at 924 and the reliable positioning outputs obtained at 934. For example, the positioning model statistics may indicate at least one of the positioning approach used at 924 (e.g., whether a direct positioning model was used, whether an indirect positioning model (i.e., assisted positioning model) was used), a number of TRPs associated with the positioning signals measured at 916, an ID of a TRP (i.e., TRP ID) associated with the positioning signals measured at 916, an ID of a positioning model used at 924, a type of positioning output calculated at 924 (e.g., location, LOS indication, angle, timing), bandwidth (BW) settings used to collect the measurements at 916, an area associated with the positioning target wireless device 902 (e.g., cell ID, physical ID, logical ID), a location indicator associated with the positioning target wireless device 902 (e.g., latitude, longitude, elevation), timing information associated with the measurement taken at 916 (e.g., time duration, coordinated universal time (UTC) start timing, UTC stop timing), or a positioning error (e.g., K-percentile of positioning error based on N monitoring occasions, average positioning error based on N monitoring occasions). The positioning error may be indicated as a comparison of absolute locations (e.g., 3D), a comparison of horizontal locations, or a comparison of vertical locations. At 942, the positioning target wireless device 902 may store the positioning model statistics calculated at 938.

At 918, the set of positioning neighbor wireless devices 904 may measure the set of positioning signals 914 received from the positioning target wireless device 902. At 926, the at least one of the set of positioning neighbor wireless devices 904 may calculate a set of positioning model outputs using a set of positioning models based on the measurements taken at 918. At 936, the at least one of the set of positioning neighbor wireless devices 904 may obtain reliable output data. For example, the location of the positioning target wireless device 902 may be known, and a user may input the known location to the positioning target wireless device 902. In another example, an intermediate measurement associated with the positioning target wireless device 902 may be known, and a user may input the known location to the positioning target wireless device 902. In another example, a reliable sensor (e.g., GNSS, GPS, LIDAR) may be used to calculate the position of the positioning target wireless device 902. In another example, a reliable positioning method or algorithm (e.g., an RTT calculation) may be used to calculate the position of the positioning target wireless device 902.

At 940, the at least one of the set of positioning neighbor wireless devices 904 may calculate positioning model statistics based on a comparison of the calculated positioning model outputs at 926 and the reliable positioning outputs obtained at 936. For example, the positioning model statistics may indicate at least one of the positioning approach used at 926 (e.g., whether a direct positioning model was used, whether an indirect positioning model (i.e., assisted positioning model) was used), a number of TRPs associated with the positioning signals measured at 918, an ID of the TRP (i.e., TRP ID) measuring the positioning signals at 918, an ID of a positioning model used at 926, a type of positioning output calculated at 926 (e.g., location, LOS indication, angle, timing), BW settings used to collect the measurements at 918, an area associated with the at least one of the set of positioning neighbor wireless devices 904 (e.g., cell ID, physical ID, logical ID), a location indicator associated with the at least one of the set of positioning neighbor wireless devices 904 (e.g., latitude, longitude, elevation), timing information associated with the measurement taken at 918 (e.g., time duration, UTC start timing, UTC stop timing), or a positioning error (e.g., K-percentile of positioning error based on N monitoring occasions, average positioning error based on N monitoring occasions). The positioning error may be indicated as a comparison of absolute locations (e.g., 3D), a comparison of horizontal locations, or a comparison of vertical locations. At 944, the at least one of the set of positioning neighbor wireless devices 904 may store the positioning model statistics calculated at 940.

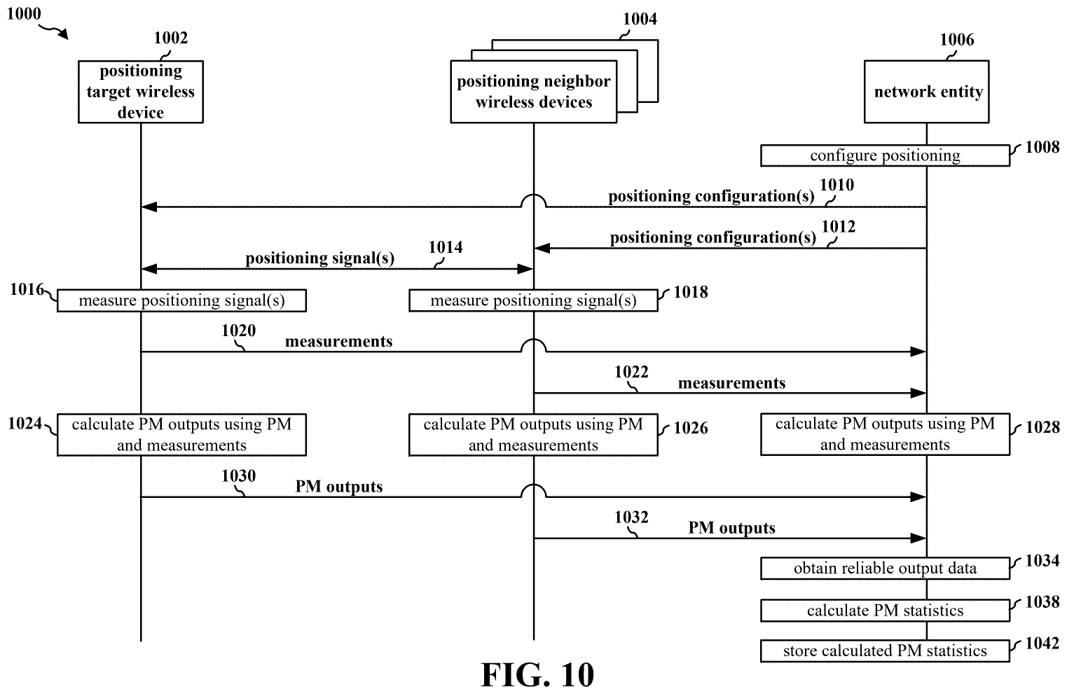

FIG. 10 is a connection flow diagram 1000 illustrating an example of a network entity 1006 configured to store calculated PM statistics based on usage of a positioning model. The network entity 1006 may be configured to configure positioning for a set of positioning signals (e.g., SRS, PRS, SSB) measured by a wireless device, such as the positioning target wireless device 1002 or the set of positioning neighbor wireless devices 1004. The positioning target wireless device 1002 may be a UE or a PRU. The set of positioning neighbor wireless devices 1004 may include a set of base stations and/or a set of TRPs. The network entity 1006 may include an LMF or a set of location servers.

AT 1008 the network entity 1006 may configure positioning for the positioning target wireless device 1002 and the set of positioning neighbor wireless devices 1004. The configuration may include a configuration for the set of positioning neighbor wireless devices 1004 to transmit a set of positioning signals 1014 at the positioning target wireless device 1002, and for the positioning target wireless device 1002 to measure the set of positioning signals 1014 received from the set of positioning neighbor wireless devices 1004 for a set of positioning models. The configuration may include a configuration for the positioning target wireless device 1002 to transmit a set of positioning signals 1014 at the set of positioning neighbor wireless devices 1004, and for the set of positioning neighbor wireless devices 1004 to measure the set of positioning signals 1014 received from the positioning target wireless device 1002 for a set of positioning models.

The network entity 1006 may transmit a set of positioning configurations 1010 at the positioning target wireless device 1002. The positioning target wireless device 1002 may receive the set of positioning configurations 1010 from the network entity 1006. The network entity may transmit a set of positioning configurations 1012 at the set of positioning neighbor wireless devices 1004. The set of positioning neighbor wireless devices 1004 may receive the set of positioning configurations 1012 from the network entity 1006. The set of positioning neighbor wireless devices 1004 may transmit the positioning signals 1014 at the positioning target wireless device 1002 based on the set of positioning configurations 1012 received from the network entity 1006. The set of positioning signals 1014 may include a set of positioning RSs, for example PRSs, and/or SSBs. The positioning target wireless device 1002 may transmit the positioning signals 1014 at the set of positioning neighbor wireless devices 1004 based on the set of positioning configurations 1010 received from the network entity 1006. The set of positioning signals 1014 may include a set of positioning RSs, for example SRSs, and/or SSBs.

At 1016, the positioning target wireless device 1002 may measure the set of positioning signals 1014 received from the set of positioning neighbor wireless devices 1004. In some aspects, the positioning target wireless device 1002 may transmit the set of measurements 1020 taken at 1016 to the network entity 1006. At 1018, the set of positioning neighbor wireless devices 1004 may measure the set of positioning signals 1014 received from the positioning target wireless device 1002.

In some aspects, the positioning target wireless device 1002 may transmit the set of measurements 1020 taken at 1016 to the network entity 1006. In some aspects, the set of positioning neighbor wireless devices 1004 may transmit the set of measurements 1022 taken at 1018 to the network entity 1006. In such aspects, at 1028, the network entity 1006 may calculate a set of positioning model outputs based on the set of measurements 1020 and/or the set of measurements 1022.

In other aspects, at 1024, the positioning target wireless device 1002 may calculate a set of positioning model outputs using a set of positioning models based on the measurements taken at 1016. The positioning target wireless device 1002 may transmit the set of positioning model outputs 1030 to the network entity 1006. At 1026, the at least one of the set of positioning neighbor wireless devices 1004 may calculate a set of positioning model outputs using a set of positioning models based on the measurements taken at 1018. The at least one of the set of positioning neighbor wireless devices 1004 may transmit the set of positioning model outputs 1032 to the network entity 1006.

At 1034, the network entity 1006 may obtain reliable output data. For example, the location of the positioning target wireless device 1002 may be known, and a user may input the known location to the positioning target wireless device 1002. In another example, an intermediate measurement associated with the positioning target wireless device 1002 may be known, and a user may input the known location to the positioning target wireless device 1002. In another example, a reliable sensor (e.g., GNSS, GPS, LIDAR) may be used to calculate the position of the positioning target wireless device 1002. In another example, a reliable positioning method or algorithm (e.g., an RTT calculation) may be used to calculate the position of the positioning target wireless device 1002.

At 1038, the network entity 1006 may calculate positioning model statistics based on a comparison of the calculated positioning model outputs at 1024, 1026, and/or 1028 and the reliable positioning outputs obtained at 1034. At 1042, the network entity 1006 may store the positioning model statistics calculated at 1038.

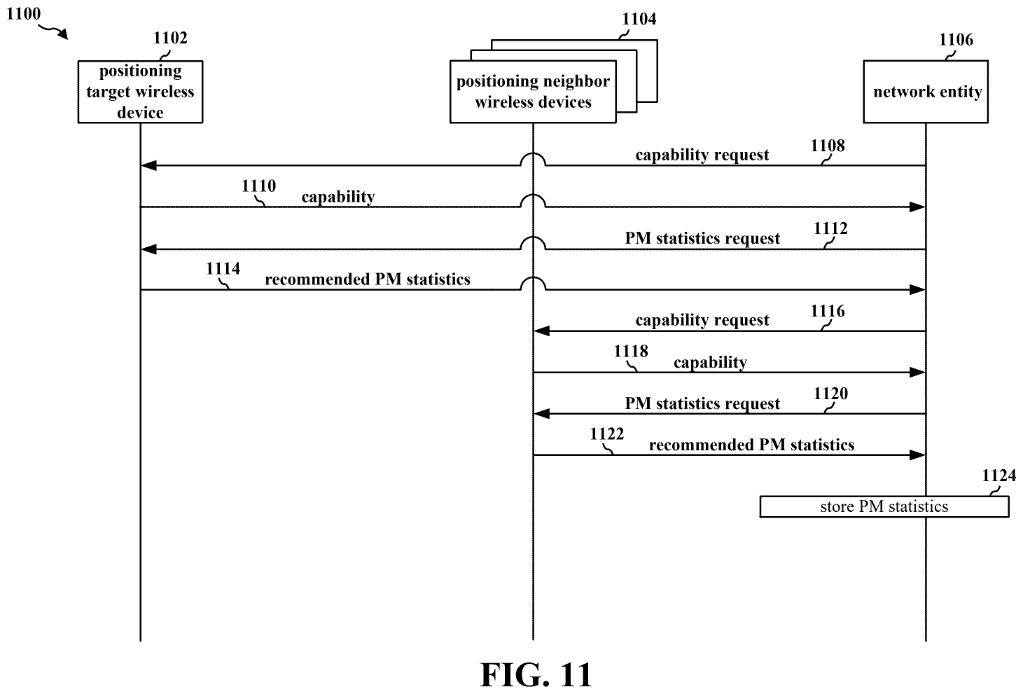

FIG. 11 is another connection flow diagram 1100 illustrating an example of a network entity 1106 configured to store calculated PM statistics collected from other wireless devices, for example the positioning target wireless device 902 or one of the set of positioning neighbor wireless devices 904 in FIG. 9.

The network entity 1106 may transmit an indicator of a capability request 1108 to the positioning target wireless device 1102. The positioning target wireless device 1102 may receive the indicator of a capability request 1108 from the network entity 1106. The capability request 1108 may request the positioning target wireless device 1102 to provide its capability to recommend positioning model statistics based on historical positioning approaches used by the positioning target wireless device 1102. The positioning target wireless device 1102 may transmit an indicator of the capability 1110 to the network entity 1106. The network entity 1106 may receive the indicator of the capability 1110 from the positioning target wireless device 1102. The capability 1110 may indicate the capability of the positioning target wireless device 1102 to provide recommended positioning model statistics to the network entity 1106.

In response to receiving an indicator of the capability 1110 from the positioning target wireless device 1102, the network entity 1106 may transmit an indicator of a request 1112 for a set of recommended positioning model statistics to the positioning target wireless device 1102. The positioning target wireless device 1102 may receive the indicator of the request 1112 for a set of recommended positioning model statistics from the network entity 1106. The request 1112 may request the positioning target wireless device 1102 to provide recommended positioning model statistics to the network entity 1106. The positioning target wireless device 1102 may transmit an indicator of a set of recommended positioning model statistics 1114 to the network entity 1106. The network entity 1106 may receive the indicator of the set of recommended positioning model statistics 1114 from the positioning target wireless device 1102.

Similarly, the network entity 1106 may transmit an indicator of a capability request 1116 to at least one of the set of positioning neighbor wireless devices 1104. The at least one of the set of positioning neighbor wireless devices 1104 may receive the indicator of a capability request 1116 from the network entity 1106. The capability request 1116 may request the at least one of the set of positioning neighbor wireless devices 1104 to provide its capability to recommend positioning model statistics based on historical positioning approaches used by the at least one of the set of positioning neighbor wireless devices 1104. The at least one of the set of positioning neighbor wireless devices 1104 may transmit an indicator of the capability 1118 to the network entity 1106. The network entity 1106 may receive the indicator of the capability 1118 from the at least one of the set of positioning neighbor wireless devices 1104. The capability 1118 may indicate the capability of the at least one of the set of positioning neighbor wireless devices 1104 to provide recommended positioning model statistics to the network entity 1106.

In response to receiving an indicator of the capability 1118 from the at least one of the set of positioning neighbor wireless devices 1104, the network entity 1106 may transmit an indicator of a request 1120 for a set of recommended positioning model statistics to the at least one of the set of positioning neighbor wireless devices 1104. The at least one of the set of positioning neighbor wireless devices 1104 may receive the indicator of the request 1120 for a set of recommended positioning model statistics from the network entity 1106. The request 1120 may request the at least one of the set of positioning neighbor wireless devices 1104 to provide recommended positioning model statistics to the network entity 1106. The at least one of the set of positioning neighbor wireless devices 1104 may transmit an indicator of a set of recommended positioning model statistics 1122 to the network entity 1106. The network entity 1106 may receive the indicator of the set of recommended positioning model statistics 1122 from the at least one of the set of positioning neighbor wireless devices 1104.

At 1124, the network entity 1106 may store the received positioning model statistics on its memory. In some aspects, the network entity 1106 may group recommended statistics and settings from a large number of wireless devices, and apply a majority rule for providing recommendations to other wireless devices, or for configuring positioning settings for other wireless devices.

The positioning model statistics stored by wireless devices of FIG. 9, 10, or 11 may be used to provide recommendations of positioning model statistics to wireless devices for optimal positioning.

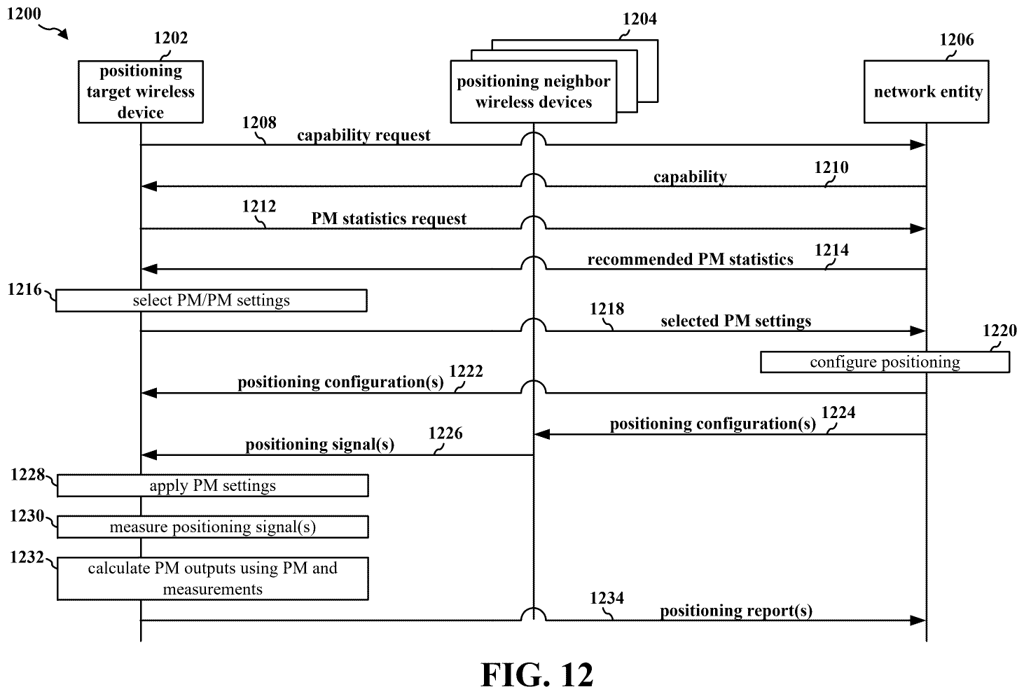

FIG. 12 is a connection flow diagram 1200 illustrating an example of a positioning target wireless device 1202 configured to apply positioning model settings based on recommended positioning model statistics.

The positioning target wireless device 1202 may transmit an indicator of a capability request 1208 to the network entity 1206. The network entity 1206 may receive the indicator of a capability request 1208 from the positioning target wireless device 1202. The capability request 1208 may request the network entity 1206 to provide its capability to recommend positioning model statistics based on historical positioning approaches accessible by the network entity 1206. The network entity 1206 may transmit an indicator of the capability 1210 to the positioning target wireless device 1202. The positioning target wireless device 1202 may receive the indicator of the capability 1210 from the network entity 1206. The capability 1210 may indicate the capability of the network entity 1206 to provide recommended positioning model statistics to the positioning target wireless device 1202.

In response to receiving an indicator of the capability 1210 from the network entity 1206, the positioning target wireless device 1202 may transmit an indicator of a request 1212 for a set of recommended positioning model statistics to the network entity 1206. The network entity 1206 may receive the indicator of the request 1212 for a set of recommended positioning model statistics from the positioning target wireless device 1202. The request 1212 may request the network entity 1206 to provide recommended positioning model statistics to the positioning target wireless device 1202. The network entity 1206 may transmit an indicator of a set of recommended positioning model statistics 1214 to the positioning target wireless device 1202. The positioning target wireless device 1202 may receive the indicator of the set of recommended positioning model statistics 1214 from the network entity 1206.

At 1216, the positioning target wireless device 1202 may select a set of positioning models and a set of positioning model statistics based on the set of recommended positioning model statistics 1214. The positioning target wireless device 1202 may transmit an indicator of the selected positioning model settings 1218 to the network entity 1206.

At 1220, the network entity 1206 may configure positioning for the positioning target wireless device 1202 and the set of positioning neighbor wireless devices 1204. The configuration may include a configuration for the set of positioning neighbor wireless devices 1204 to transmit a set of positioning signals 1226 at the positioning target wireless device 1202, and for the positioning target wireless device 1202 to measure the set of positioning signals 1226 received from the set of positioning neighbor wireless devices 1204 for a set of positioning models. In some aspects, the network entity 1206 may aggregate a set of recommended positioning model statistics from a plurality of wireless devices, and may select a subset of recommended statistics for positioning. For example, different sets of recommendation statistics may be associated with different location indicators (e.g., latitude, longitude, elevation), and the network entity 1206 may select a set of recommendation statistics associated with a region associated with a current estimate of the location indicators of the positioning target wireless device 1202.

The network entity 1206 may transmit a set of positioning configurations 1222 at the positioning target wireless device 1202. The positioning target wireless device 1202 may receive the set of positioning configurations 1222 from the network entity 1206. The network entity may transmit a set of positioning configurations 1224 at the set of positioning neighbor wireless devices 1204. The set of positioning neighbor wireless devices 1204 may receive the set of positioning configurations 1224 from the network entity 1206. The set of positioning neighbor wireless devices 1204 may transmit the signals 1226 at the positioning target wireless device 1202 based on the set of positioning configurations 1224 received from the network entity 1206. The set of positioning signals 1226 may include a set of positioning RSs, for example PRSs, and/or SSBs.

At 1228, the positioning target wireless device 1202 may apply the settings selected at 1216. At 1230, the positioning target wireless device 1202 may measure the set of positioning signals 1226. At 1232, the positioning target wireless device 1202 may calculate a set of positioning model outputs based on the applied settings at 1228. The positioning target wireless device 1202 may transmit a set of positioning reports 1234 to the network entity 1206 based on the calculation at 1232.

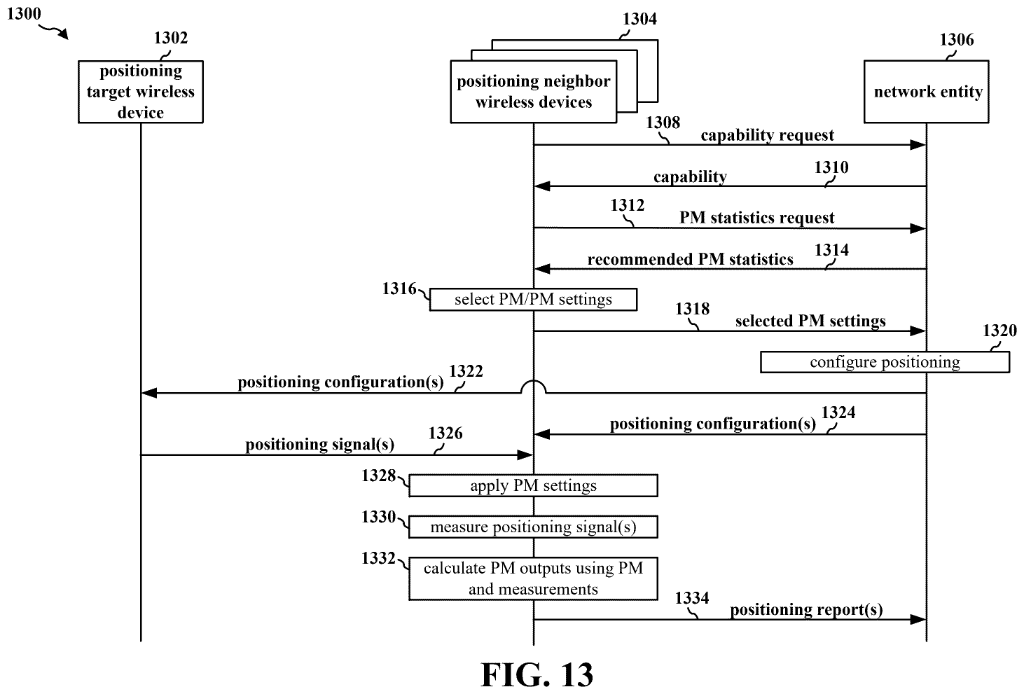

FIG. 13 is a connection flow diagram 1300 illustrating an example of at least one of a set of positioning neighbor wireless devices 1204 configured to apply positioning model settings based on recommended positioning model statistics.

The positioning target wireless device 1302 may transmit an indicator of a capability request 1308 to the network entity 1306. The network entity 1306 may receive the indicator of a capability request 1308 from the positioning target wireless device 1302. The capability request 1308 may request the network entity 1306 to provide its capability to recommend positioning model statistics based on historical positioning approaches accessible by the network entity 1306. The network entity 1306 may transmit an indicator of the capability 1310 to the positioning target wireless device 1302. The positioning target wireless device 1302 may receive the indicator of the capability 1310 from the network entity 1306. The capability 1310 may indicate the capability of the network entity 1306 to provide recommended positioning model statistics to the positioning target wireless device 1302.

In response to receiving an indicator of the capability 1310 from the network entity 1306, the positioning target wireless device 1302 may transmit an indicator of a request 1312 for a set of recommended positioning model statistics to the network entity 1306. The network entity 1306 may receive the indicator of the request 1312 for a set of recommended positioning model statistics from the positioning target wireless device 1302. The request 1312 may request the network entity 1306 to provide recommended positioning model statistics to the positioning target wireless device 1302. The network entity 1306 may transmit an indicator of a set of recommended positioning model statistics 1314 to the positioning target wireless device 1302. The positioning target wireless device 1302 may receive the indicator of the set of recommended positioning model statistics 1314 from the network entity 1306.

At 1316, the positioning target wireless device 1302 may select a set of positioning models and a set of positioning model statistics based on the set of recommended positioning model statistics 1314. The positioning target wireless device 1302 may transmit an indicator of the selected positioning model settings 1318 to the network entity 1306.

At 1320, the network entity 1306 may configure positioning for the positioning target wireless device 1302 and the set of positioning neighbor wireless devices 1304. The configuration may include a configuration for the set of positioning neighbor wireless devices 1304 to transmit a set of positioning signals 1326 at the positioning target wireless device 1302, and for the positioning target wireless device 1302 to measure the set of positioning signals 1326 received from the set of positioning neighbor wireless devices 1304 for a set of positioning models. In some aspects, the network entity 1306 may aggregate a set of recommended positioning model statistics from a plurality of wireless devices, and may select a subset of recommended statistics for positioning. For example, different sets of recommendation statistics may be associated with different location indicators (e.g., latitude, longitude, elevation), and the network entity 1306 may select a set of recommendation statistics associated with a region associated with a current estimate of the location indicators of the positioning target wireless device 1302.

The network entity 1306 may transmit a set of positioning configurations 1322 at the positioning target wireless device 1302. The positioning target wireless device 1302 may receive the set of positioning configurations 1322 from the network entity 1306. The network entity may transmit a set of positioning configurations 1324 at the set of positioning neighbor wireless devices 1304. The set of positioning neighbor wireless devices 1304 may receive the set of positioning configurations 1324 from the network entity 1306. The set of positioning neighbor wireless devices 1304 may transmit the signals 1326 at the positioning target wireless device 1302 based on the set of positioning configurations 1324 received from the network entity 1306. The set of positioning signals 1326 may include a set of positioning RSs, for example PRSs, and/or SSBs.

At 1328, the positioning target wireless device 1302 may apply the settings selected at 1316. At 1330, the positioning target wireless device 1302 may measure the set of positioning signals 1326. At 1332, the positioning target wireless device 1302 may calculate a set of positioning model outputs based on the applied settings at 1328. The positioning target wireless device 1302 may transmit a set of positioning reports 1334 to the network entity 1306 based on the calculation at 1332.

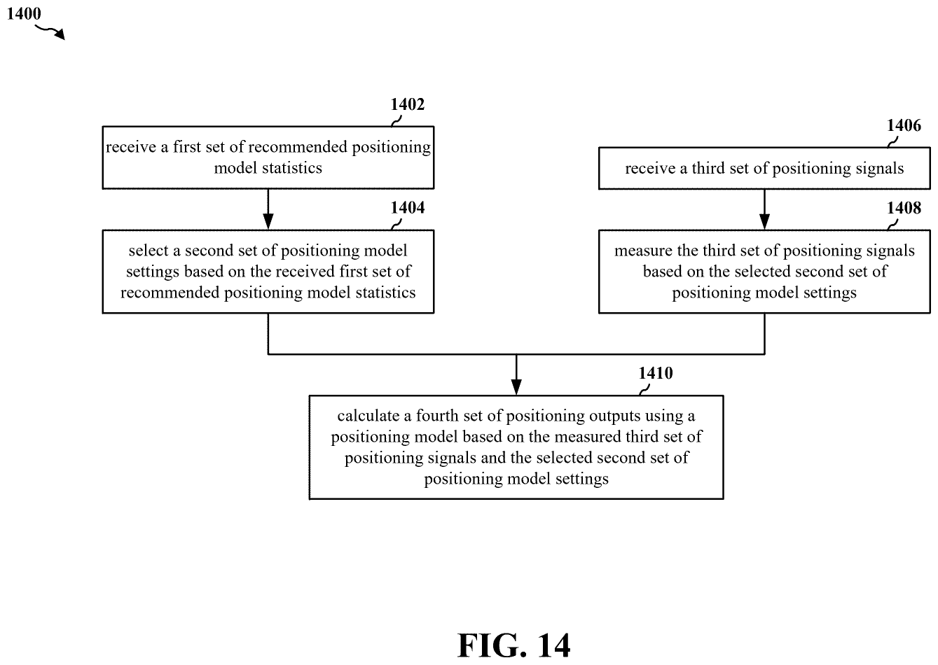

FIG. 14 is a flowchart 1400 of a method of wireless communication. The method may be performed by a wireless device (e.g., the UE 104, the UE 350; the base station 102, the base station 310; the wireless device 402, the wireless device 404, the wireless device 406, the wireless device 502, the wireless device 504, the wireless device 506; the wireless device 706, the wireless device 756, the wireless device 864; the positioning target wireless device 902, the positioning target wireless device 1202; one of the positioning neighbor wireless devices 904, one of the positioning neighbor wireless devices 1304; the network entity 1602, the network entity 1702; the apparatus 1604). At 1402, the wireless device may receive a first set of recommended positioning model statistics. For example, 1402 may be performed by the positioning target wireless device 1202 in FIG. 12, which may receive a first set of recommended positioning model statistics. Moreover, 1402 may be performed by the component 198 in FIG. 1, 3, 16, or 17.

At 1404, the wireless device may select a second set of positioning model settings based on the received first set of recommended positioning model statistics. For example, 1404 may be performed by the positioning target wireless device 1202 in FIG. 12, which may select a second set of positioning model settings based on the received first set of recommended positioning model statistics. Moreover, 1404 may be performed by the component 198 in FIG. 1, 3, 16, or 17.

At 1406, the wireless device may receive a third set of positioning signals. For example, 1406 may be performed by the positioning target wireless device 1202 in FIG. 12, which may receive a third set of positioning signals. Moreover, 1406 may be performed by the component 198 in FIG. 1, 3, 16, or 17.

At 1408, the wireless device may measure the third set of positioning signals based on the selected second set of positioning model settings. For example, 1408 may be performed by the positioning target wireless device 1202 in FIG. 12, which may measure the third set of positioning signals based on the selected second set of positioning model settings. Moreover, 1408 may be performed by the component 198 in FIG. 1, 3, 16, or 17.

At 1410, the wireless device may calculate a fourth set of positioning outputs using a positioning model based on the measured third set of positioning signals and the selected second set of positioning model settings. For example, 1410 may be performed by the positioning target wireless device 1202 in FIG. 12, which may calculate a fourth set of positioning outputs using a positioning model based on the measured third set of positioning signals and the selected second set of positioning model settings. Moreover, 1410 may be performed by the component 198 in FIG. 1, 3, 16, or 17.

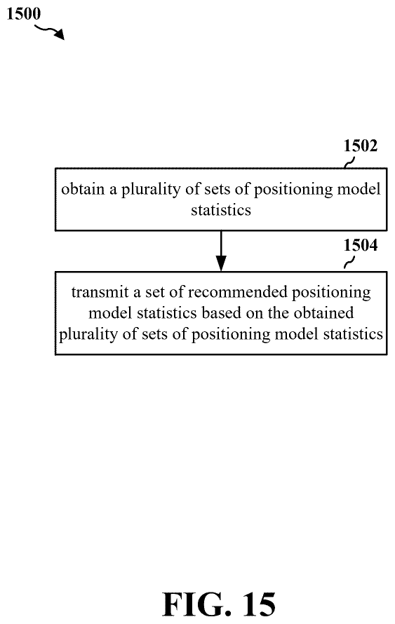

FIG. 15 is a flowchart 1500 of a method of wireless communication. The method may be performed by a wireless device (e.g., the UE 104, the UE 350; the base station 102, the base station 310; the wireless device 402, the wireless device 404, the wireless device 406, the wireless device 502, the wireless device 504, the wireless device 506; the wireless device 706, the wireless device 756, the wireless device 864; the positioning target wireless device 902, the positioning target wireless device 1202; one of the positioning neighbor wireless devices 904, one of the positioning neighbor wireless devices 1304; the network entity 1206, the network entity 1306, the network entity 1602, the network entity 1702; the apparatus 1604). At 1502, the wireless device may obtain a plurality of sets of positioning model statistics. For example, 1502 may be performed by the network entity 1206 in FIG. 12, which may obtain a plurality of sets of positioning model statistics. Moreover, 1502 may be performed by the component 199 in FIG. 1, 3, 16, 17, or 18.

At 1504, the wireless device may transmit a set of recommended positioning model statistics based on the obtained plurality of sets of positioning model statistics. For example, 1504 may be performed by the network entity 1206 in FIG. 12, which may transmit a set of recommended positioning model statistics based on the obtained plurality of sets of positioning model statistics. Moreover, 1504 may be performed by the component 199 in FIG. 1, 3, 16, 17, or 18.

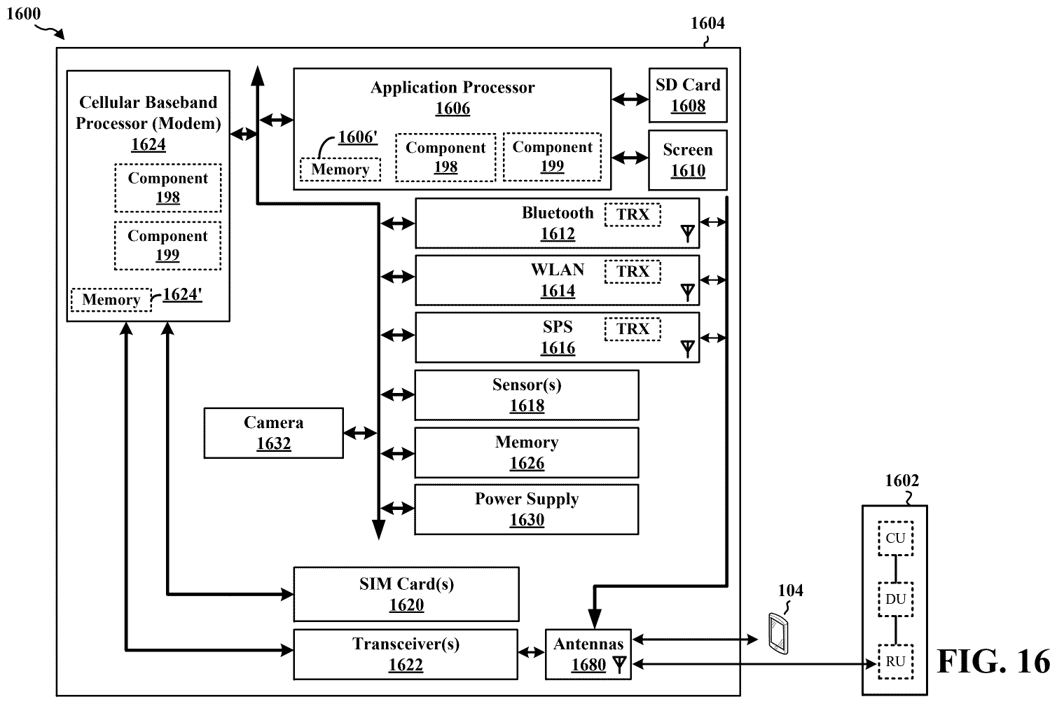

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The cellular baseband processor(s) 1624 and the application processor(s) 1606 are configured to perform the various functions described supra based at least in part of the information stored in the memory. That is, the cellular baseband processor(s) 1624 and the application processor(s) 1606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the component 198 may be configured to receive a first set of recommended positioning model statistics. The component 198 may be configured to select a second set of positioning model settings based on the received first set of recommended positioning model statistics. The component 198 may be configured to receive a third set of positioning signals. The component 198 may be configured to measure the third set of positioning signals based on the selected second set of positioning model settings. The component 198 may be configured to calculate a fourth set of positioning outputs using a positioning model based on the measured third set of positioning signals and the selected second set of positioning model settings. The component 198 may be within the cellular baseband processor(s) 1624, the application processor(s) 1606, or both the cellular baseband processor(s) 1624 and the application processor(s) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for receiving a first set of recommended positioning model statistics. The apparatus 1604 may include means for selecting a second set of positioning model settings based on the received first set of recommended positioning model statistics. The apparatus 1604 may include means for receiving a third set of positioning signals. The apparatus 1604 may include means for measuring the third set of positioning signals based on the selected second set of positioning model settings. The apparatus 1604 may include means for calculating a fourth set of positioning outputs using a positioning model based on the measured third set of positioning signals and the selected second set of positioning model settings. The apparatus 1604 may include means for transmitting a positioning report. The positioning report may include an indicator of the calculated fourth set of positioning outputs. The apparatus 1604 may include means for calculating a position of a UE based on the calculated fourth set of positioning outputs. The apparatus 1604 may include means for transmitting a positioning report. The positioning report may include an indicator of the calculated position of the UE. The received first set of recommended positioning model statistics may include a fifth set of BW settings. The received first set of recommended positioning model statistics may include a number of TRPs. The received first set of recommended positioning model statistics may include a sixth set of TRP IDs. The received first set of recommended positioning model statistics may include a seventh set of positioning model IDs. The received first set of recommended positioning model statistics may include an eighth set of cell IDs. The received first set of recommended positioning model statistics may include a ninth set of location indicators. The received first set of recommended positioning model statistics may include a tenth set of timing indicators. The received first set of recommended positioning model statistics may include an indicator of a ranking for a set of positioning settings. The received first set of recommended positioning model statistics may include an eleventh set of positioning model inputs and a twelfth set of positioning model outputs used on the positioning model. The ninth set of location indicators may include a thirteenth set of indicators associated with a fourteenth set of latitudes. The ninth set of location indicators may include a fifteenth set of indicators associated with a sixteenth set of longitudes. The ninth set of location indicators may include a seventeenth set of indicators associated with an eighteenth set of elevations. The apparatus 1604 may include means for selecting a thirteenth set of cells based on the ninth set of location indicators. The apparatus 1604 may include means for selecting the second set of positioning model settings based on the received first set of recommended positioning model statistics by selecting the second set of positioning model settings based on the selected thirteenth set of cells. The apparatus 1604 may include means for transmitting a request message. The request message may include an indicator of a request for the first set of recommended positioning model statistics before the reception of the first set of recommended positioning model statistics. The apparatus 1604 may include means for receiving a capability message. The capability message may include a second indicator of a capability of a second wireless device to transmit the first set of recommended positioning model statistics. The transmission of the request message may be based on the capability of the second wireless device to transmit the first set of recommended positioning model statistics. The apparatus 1604 may include means for transmitting a second request message before the reception of the capability message. The second request message may include a third indicator of a second request for the capability message. The apparatus 1604 may include means for selecting the positioning model based on the received first set of recommended positioning model statistics. The apparatus 1604 may include means for selecting the second set of positioning model settings based on the received first set of recommended positioning model statistics by selecting a subset of the first set of recommended positioning model statistics based on a fifth set of measurement selection criteria. The fifth set of measurement selection criteria may include a delay spread threshold range. The fifth set of measurement selection criteria may include a LOS peak width. The fifth set of measurement selection criteria may include a Rician factor. The fifth set of measurement selection criteria may include a number of TRPs. The fifth set of measurement selection criteria may include a TRP ID. The apparatus 1604 may include a UE. The apparatus 1604 may include a TRP. The apparatus 1604 may include a base station. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, the component 199 may be configured to obtain a plurality of sets of positioning model statistics. The component 199 may be configured to transmit a set of recommended positioning model statistics based on the obtained plurality of sets of positioning model statistics. The component 199 may be within the cellular baseband processor(s) 1624, the application processor(s) 1606, or both the cellular baseband processor(s) 1624 and the application processor(s) 1606. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for obtaining a plurality of sets of positioning model statistics. The apparatus 1604 may include means for transmitting a set of recommended positioning model statistics based on the obtained plurality of sets of positioning model statistics. The apparatus 1604 may include means for obtaining the plurality of sets of positioning model statistics by (a) obtaining a second plurality of sets of positioning signal measurements, (b) calculating a third plurality of sets of positioning outputs using a positioning model based on the second plurality of sets of positioning signal measurements, (c) obtaining a fourth plurality of sets of reliable positioning output data, and (d) calculating the plurality of sets of positioning model statistics based on a comparison of the calculated third plurality of sets of positioning outputs against the fourth plurality of sets of reliable positioning output data. The apparatus 1604 may include means for obtaining the second plurality of sets of positioning signal measurements by (a) receiving a second set of positioning signals and a third set of positioning signals, and (b) measuring the second set of positioning signals and the third set of positioning signals. The second plurality of sets of positioning signal measurements may include the measured second set of positioning signals and the measured third set of positioning signals. The apparatus 1604 may include means for obtaining the second plurality of sets of positioning signal measurements by receiving a second set of positioning signal measurements and a third set of positioning signal measurements. The second plurality of sets of positioning signal measurements may include the measured second set of positioning signals and the measured third set of positioning signals. The apparatus 1604 may include means for obtaining the fourth plurality of sets of reliable positioning output data by calculating a second set of reliable positioning output data based on a third set of positioning sensors. The fourth plurality of sets of reliable positioning output data may include the second set of reliable positioning output data. The third set of positioning sensors may include a GNSS receiver. The third set of positioning sensors may include a GPS receiver. The third set of positioning sensors may include an accelerometer. The third set of positioning sensors may include a LIDAR sensor. The apparatus 1604 may include means for obtaining the fourth plurality of sets of reliable positioning output data by calculating a second set of reliable positioning output data based on a second positioning model. The fourth plurality of sets of reliable positioning output data may include the second set of reliable positioning output data. The apparatus 1604 may include means for obtaining the fourth plurality of sets of reliable positioning output data by receiving a second set of reliable positioning output data. The fourth plurality of sets of reliable positioning output data may include the second set of reliable positioning output data. The apparatus 1604 may include means for calculating the third plurality of sets of positioning outputs using the positioning model based on the second plurality of sets of positioning signal measurements by (a) selecting a subset of the second plurality of sets of positioning signal measurements based on measurement selection criteria, and (b) calculating the third plurality of sets of positioning outputs using the positioning model based on the selected subset of the second plurality of sets of positioning signal measurements. The measurement selection criteria may include a delay spread threshold range. The measurement selection criteria may include an LOS peak width. The measurement selection criteria may include a Rician factor. The measurement selection criteria may include a number of TRPs. The measurement selection criteria may include or a TRP ID. The calculated third plurality of sets of positioning outputs may include a location of a UE. The calculated third plurality of sets of positioning outputs may include an LOS identification metric. The calculated third plurality of sets of positioning outputs may include a timing measurement. The calculated third plurality of sets of positioning outputs may include an angle measurement. The apparatus 1604 may include means for obtaining the plurality of sets of positioning model statistics by receiving a second set of positioning model statistics and a third set of positioning model statistics. The plurality of sets of positioning model statistics may include the second set of positioning model statistics and the third set of positioning model statistics. The apparatus 1604 may include means for selecting the set of recommended positioning model statistics from the plurality of sets of positioning model statistics based on a fourth set of positioning error criteria. The fourth set of positioning error criteria may include a positioning error percentile. The fourth set of positioning error criteria may include an average positioning error range. The fourth set of positioning error criteria may include a positioning error range. The fourth set of positioning error criteria may include a number of positioning occasions. The fourth set of positioning error criteria may include a recommendation ranking. The plurality of sets of positioning model statistics may include a first indicator of a positioning error percentile. The plurality of sets of positioning model statistics may include a second indicator of an average positioning error. The plurality of sets of positioning model statistics may include a third indicator of a positioning error range. The plurality of sets of positioning model statistics may include a number of positioning occasions. The apparatus 1604 may include a UE. The apparatus 1604 may include a TRP. The apparatus 1604 may include a base station. The apparatus 1604 may include an LMF. The means may be the component 199 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

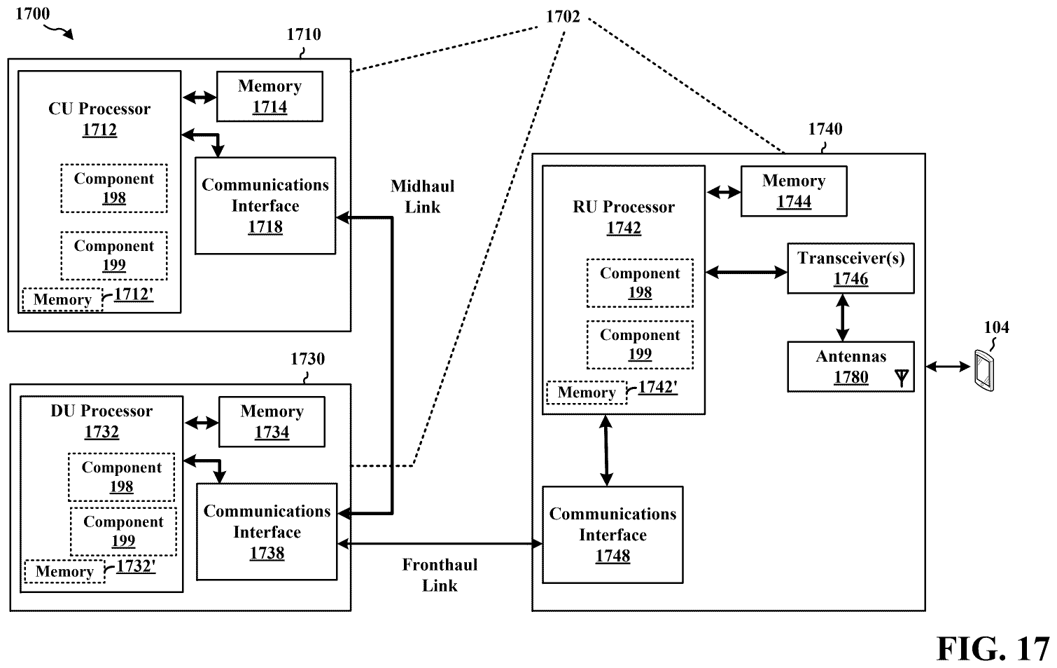

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712. The CU processor(s) 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732. The DU processor(s) 1732 may include on-chip memory 1732′. In some aspects, the DU 1730 may further include additional memory modules 1734 and a communications interface 1738. The DU 1730 communicates with the RU 1740 through a fronthaul link. The RU 1740 may include at least one RU processor 1742. The RU processor(s) 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive a first set of recommended positioning model statistics. The component 198 may be configured to select a second set of positioning model settings based on the received first set of recommended positioning model statistics. The component 198 may be configured to receive a third set of positioning signals. The component 198 may be configured to measure the third set of positioning signals based on the selected second set of positioning model settings. The component 198 may be configured to calculate a fourth set of positioning outputs using a positioning model based on the measured third set of positioning signals and the selected second set of positioning model settings. The component 198 may be within one or more processors of one or more of the CU 1710, DU 1730, and the RU 1740. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 may include means for receiving a first set of recommended positioning model statistics. The network entity 1702 may include means for selecting a second set of positioning model settings based on the received first set of recommended positioning model statistics. The network entity 1702 may include means for receiving a third set of positioning signals. The network entity 1702 may include means for measuring the third set of positioning signals based on the selected second set of positioning model settings. The network entity 1702 may include means for calculating a fourth set of positioning outputs using a positioning model based on the measured third set of positioning signals and the selected second set of positioning model settings. The network entity 1702 may include means for transmitting a positioning report. The positioning report may include an indicator of the calculated fourth set of positioning outputs. The network entity 1702 may include means for calculating a position of a UE based on the calculated fourth set of positioning outputs. The network entity 1702 may include means for transmitting a positioning report. The positioning report may include an indicator of the calculated position of the UE. The received first set of recommended positioning model statistics may include a fifth set of BW settings. The received first set of recommended positioning model statistics may include a number of TRPs. The received first set of recommended positioning model statistics may include a sixth set of TRP IDs. The received first set of recommended positioning model statistics may include a seventh set of positioning model IDs. The received first set of recommended positioning model statistics may include an eighth set of cell IDs. The received first set of recommended positioning model statistics may include a ninth set of location indicators. The received first set of recommended positioning model statistics may include a tenth set of timing indicators. The received first set of recommended positioning model statistics may include an indicator of a ranking for a set of positioning settings. The received first set of recommended positioning model statistics may include an eleventh set of positioning model inputs and a twelfth set of positioning model outputs used on the positioning model. The ninth set of location indicators may include a thirteenth set of indicators associated with a fourteenth set of latitudes. The ninth set of location indicators may include a fifteenth set of indicators associated with a sixteenth set of longitudes. The ninth set of location indicators may include a seventeenth set of indicators associated with an eighteenth set of elevations. The network entity 1702 may include means for selecting a thirteenth set of cells based on the ninth set of location indicators. The network entity 1702 may include means for selecting the second set of positioning model settings based on the received first set of recommended positioning model statistics by selecting the second set of positioning model settings based on the selected thirteenth set of cells. The network entity 1702 may include means for transmitting a request message. The request message may include an indicator of a request for the first set of recommended positioning model statistics before the reception of the first set of recommended positioning model statistics. The network entity 1702 may include means for receiving a capability message. The capability message may include a second indicator of a capability of a second wireless device to transmit the first set of recommended positioning model statistics. The transmission of the request message may be based on the capability of the second wireless device to transmit the first set of recommended positioning model statistics. The network entity 1702 may include means for transmitting a second request message before the reception of the capability message. The second request message may include a third indicator of a second request for the capability message. The network entity 1702 may include means for selecting the positioning model based on the received first set of recommended positioning model statistics. The network entity 1702 may include means for selecting the second set of positioning model settings based on the received first set of recommended positioning model statistics by selecting a subset of the first set of recommended positioning model statistics based on a fifth set of measurement selection criteria. The fifth set of measurement selection criteria may include a delay spread threshold range. The fifth set of measurement selection criteria may include a LOS peak width. The fifth set of measurement selection criteria may include a Rician factor. The fifth set of measurement selection criteria may include a number of TRPs. The fifth set of measurement selection criteria may include a TRP ID. The network entity 1702 may include a TRP. The network entity 1702 may include a base station. The means may be the component 198 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, the component 199 may be configured to obtain a plurality of sets of positioning model statistics. The component 199 may be configured to transmit a set of recommended positioning model statistics based on the obtained plurality of sets of positioning model statistics. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 may include means for obtaining a plurality of sets of positioning model statistics. The network entity 1702 may include means for transmitting a set of recommended positioning model statistics based on the obtained plurality of sets of positioning model statistics. The network entity 1702 may include means for obtaining the plurality of sets of positioning model statistics by (a) obtaining a second plurality of sets of positioning signal measurements, (b) calculating a third plurality of sets of positioning outputs using a positioning model based on the second plurality of sets of positioning signal measurements, (c) obtaining a fourth plurality of sets of reliable positioning output data, and (d) calculating the plurality of sets of positioning model statistics based on a comparison of the calculated third plurality of sets of positioning outputs against the fourth plurality of sets of reliable positioning output data. The network entity 1702 may include means for obtaining the second plurality of sets of positioning signal measurements by (a) receiving a second set of positioning signals and a third set of positioning signals, and (b) measuring the second set of positioning signals and the third set of positioning signals. The second plurality of sets of positioning signal measurements may include the measured second set of positioning signals and the measured third set of positioning signals. The network entity 1702 may include means for obtaining the second plurality of sets of positioning signal measurements by receiving a second set of positioning signal measurements and a third set of positioning signal measurements. The second plurality of sets of positioning signal measurements may include the measured second set of positioning signals and the measured third set of positioning signals. The network entity 1702 may include means for obtaining the fourth plurality of sets of reliable positioning output data by calculating a second set of reliable positioning output data based on a third set of positioning sensors. The fourth plurality of sets of reliable positioning output data may include the second set of reliable positioning output data. The third set of positioning sensors may include a GNSS receiver. The third set of positioning sensors may include a GPS receiver. The third set of positioning sensors may include an accelerometer. The third set of positioning sensors may include a LIDAR sensor. The network entity 1702 may include means for obtaining the fourth plurality of sets of reliable positioning output data by calculating a second set of reliable positioning output data based on a second positioning model. The fourth plurality of sets of reliable positioning output data may include the second set of reliable positioning output data. The network entity 1702 may include means for obtaining the fourth plurality of sets of reliable positioning output data by receiving a second set of reliable positioning output data. The fourth plurality of sets of reliable positioning output data may include the second set of reliable positioning output data. The network entity 1702 may include means for calculating the third plurality of sets of positioning outputs using the positioning model based on the second plurality of sets of positioning signal measurements by (a) selecting a subset of the second plurality of sets of positioning signal measurements based on measurement selection criteria, and (b) calculating the third plurality of sets of positioning outputs using the positioning model based on the selected subset of the second plurality of sets of positioning signal measurements. The measurement selection criteria may include a delay spread threshold range. The measurement selection criteria may include an LOS peak width. The measurement selection criteria may include a Rician factor. The measurement selection criteria may include a number of TRPs. The measurement selection criteria may include or a TRP ID. The calculated third plurality of sets of positioning outputs may include a location of a UE. The calculated third plurality of sets of positioning outputs may include an LOS identification metric. The calculated third plurality of sets of positioning outputs may include a timing measurement. The calculated third plurality of sets of positioning outputs may include an angle measurement. The network entity 1702 may include means for obtaining the plurality of sets of positioning model statistics by receiving a second set of positioning model statistics and a third set of positioning model statistics. The plurality of sets of positioning model statistics may include the second set of positioning model statistics and the third set of positioning model statistics. The network entity 1702 may include means for selecting the set of recommended positioning model statistics from the plurality of sets of positioning model statistics based on a fourth set of positioning error criteria. The fourth set of positioning error criteria may include a positioning error percentile. The fourth set of positioning error criteria may include an average positioning error range. The fourth set of positioning error criteria may include a positioning error range. The fourth set of positioning error criteria may include a number of positioning occasions. The fourth set of positioning error criteria may include a recommendation ranking. The plurality of sets of positioning model statistics may include a first indicator of a positioning error percentile. The plurality of sets of positioning model statistics may include a second indicator of an average positioning error. The plurality of sets of positioning model statistics may include a third indicator of a positioning error range. The plurality of sets of positioning model statistics may include a number of positioning occasions. The network entity 1702 may include a TRP. The network entity 1702 may include a base station. The network entity 1702 may include an LMF. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

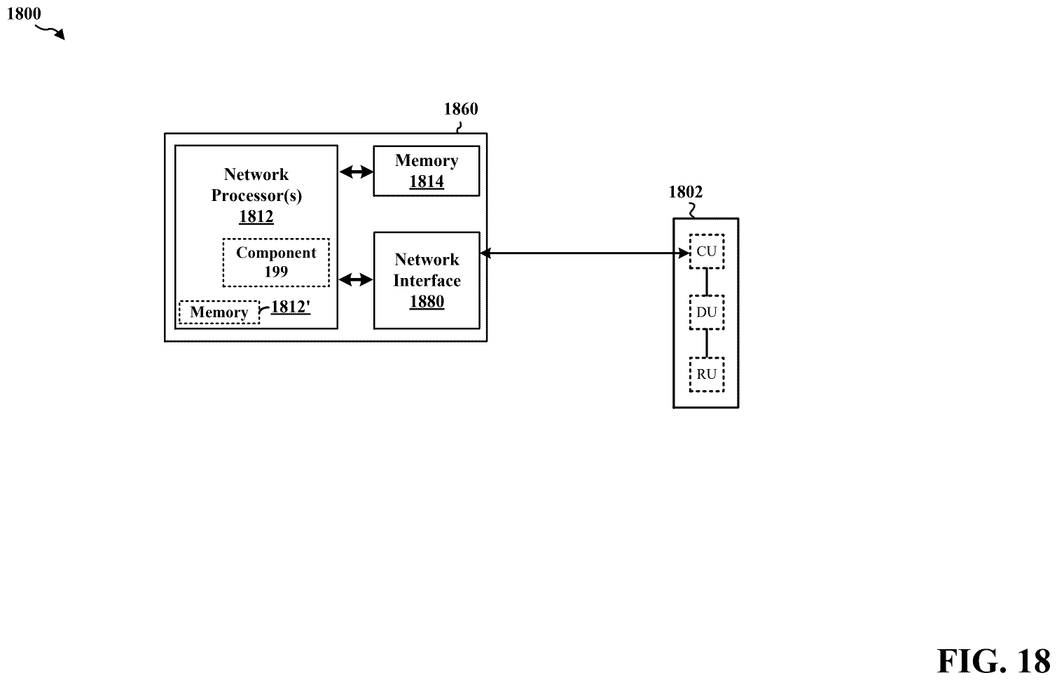

FIG. 18 is a diagram 1800 illustrating an example of a hardware implementation for a network entity 1860. In one example, the network entity 1860 may be within the core network 120. The network entity 1860 may include at least one network processor 1812. The network processor(s) 1812 may include on-chip memory 1812′. In some aspects, the network entity 1860 may further include additional memory modules 1814. The network entity 1860 communicates via the network interface 1880 directly (e.g., backhaul link) or indirectly (e.g., through a RIC) with the CU 1802. The on-chip memory 1812′ and the additional memory modules 1814 may each be considered a computer-readable medium/memory. Each computer-readable medium/memory may be non-transitory. The network processor(s) 1812 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to obtain a plurality of sets of positioning model statistics. The component 199 may be configured to transmit a set of recommended positioning model statistics based on the obtained plurality of sets of positioning model statistics. The component 199 may be within the network processor(s) 1812. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1860 may include a variety of components configured for various functions. In one configuration, the network entity 1860 may include means for obtaining a plurality of sets of positioning model statistics. The network entity 1860 may include means for transmitting a set of recommended positioning model statistics based on the obtained plurality of sets of positioning model statistics. The network entity 1860 may include means for obtaining the plurality of sets of positioning model statistics by (a) obtaining a second plurality of sets of positioning signal measurements, (b) calculating a third plurality of sets of positioning outputs using a positioning model based on the second plurality of sets of positioning signal measurements, (c) obtaining a fourth plurality of sets of reliable positioning output data, and (d) calculating the plurality of sets of positioning model statistics based on a comparison of the calculated third plurality of sets of positioning outputs against the fourth plurality of sets of reliable positioning output data. The network entity 1860 may include means for obtaining the second plurality of sets of positioning signal measurements by (a) receiving a second set of positioning signals and a third set of positioning signals, and (b) measuring the second set of positioning signals and the third set of positioning signals. The second plurality of sets of positioning signal measurements may include the measured second set of positioning signals and the measured third set of positioning signals. The network entity 1860 may include means for obtaining the second plurality of sets of positioning signal measurements by receiving a second set of positioning signal measurements and a third set of positioning signal measurements. The second plurality of sets of positioning signal measurements may include the measured second set of positioning signals and the measured third set of positioning signals. The network entity 1860 may include means for obtaining the fourth plurality of sets of reliable positioning output data by calculating a second set of reliable positioning output data based on a third set of positioning sensors. The fourth plurality of sets of reliable positioning output data may include the second set of reliable positioning output data. The third set of positioning sensors may include a GNSS receiver. The third set of positioning sensors may include a GPS receiver. The third set of positioning sensors may include an accelerometer. The third set of positioning sensors may include a LIDAR sensor. The network entity 1860 may include means for obtaining the fourth plurality of sets of reliable positioning output data by calculating a second set of reliable positioning output data based on a second positioning model. The fourth plurality of sets of reliable positioning output data may include the second set of reliable positioning output data. The network entity 1860 may include means for obtaining the fourth plurality of sets of reliable positioning output data by receiving a second set of reliable positioning output data. The fourth plurality of sets of reliable positioning output data may include the second set of reliable positioning output data. The network entity 1860 may include means for calculating the third plurality of sets of positioning outputs using the positioning model based on the second plurality of sets of positioning signal measurements by (a) selecting a subset of the second plurality of sets of positioning signal measurements based on measurement selection criteria, and (b) calculating the third plurality of sets of positioning outputs using the positioning model based on the selected subset of the second plurality of sets of positioning signal measurements. The measurement selection criteria may include a delay spread threshold range. The measurement selection criteria may include an LOS peak width. The measurement selection criteria may include a Rician factor. The measurement selection criteria may include a number of TRPs. The measurement selection criteria may include or a TRP ID. The calculated third plurality of sets of positioning outputs may include a location of a UE. The calculated third plurality of sets of positioning outputs may include an LOS identification metric. The calculated third plurality of sets of positioning outputs may include a timing measurement. The calculated third plurality of sets of positioning outputs may include an angle measurement. The network entity 1860 may include means for obtaining the plurality of sets of positioning model statistics by receiving a second set of positioning model statistics and a third set of positioning model statistics. The plurality of sets of positioning model statistics may include the second set of positioning model statistics and the third set of positioning model statistics. The network entity 1860 may include means for selecting the set of recommended positioning model statistics from the plurality of sets of positioning model statistics based on a fourth set of positioning error criteria. The fourth set of positioning error criteria may include a positioning error percentile. The fourth set of positioning error criteria may include an average positioning error range. The fourth set of positioning error criteria may include a positioning error range. The fourth set of positioning error criteria may include a number of positioning occasions. The fourth set of positioning error criteria may include a recommendation ranking. The plurality of sets of positioning model statistics may include a first indicator of a positioning error percentile. The plurality of sets of positioning model statistics may include a second indicator of an average positioning error. The plurality of sets of positioning model statistics may include a third indicator of a positioning error range. The plurality of sets of positioning model statistics may include a number of positioning occasions. The network entity 1860 may include a TRP. The network entity 1860 may include a base station. The network entity 1860 may include an LMF. The means may be the component 199 of the network entity 1860 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, may send the data to a component of the device that transmits the data, or may send the data to a component of the device. A device configured to “obtain” data, such as a transmission, signal, or message, may receive, for example with a transceiver, may obtain the data from a component of the device that receives the data, or may obtain the data from a component of the device. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, comprising: receiving a first set of recommended positioning model statistics; selecting a second set of positioning model settings based on the received first set of recommended positioning model statistics; receiving a third set of positioning signals; measuring the third set of positioning signals based on the selected second set of positioning model settings; and calculating a fourth set of positioning outputs using a positioning model based on the measured third set of positioning signals and the selected second set of positioning model settings.

Aspect 2 is the method of aspect 1, further comprising transmitting a positioning report comprising an indicator of the calculated fourth set of positioning outputs.

Aspect 3 is the method of either of aspects 1 or 2, further comprising calculating a position of a user equipment (UE) based on the calculated fourth set of positioning outputs.

Aspect 4 is the method of aspect 3, further comprising transmitting a positioning report comprising an indicator of the calculated position of the UE.

Aspect 5 is the method of any of aspects 1 to 4, wherein the received first set of recommended positioning model statistics comprise at least one of: a fifth set of bandwidth (BW) settings; a number of transmission reception points (TRPs); a sixth set of TRP identifiers (IDs); a seventh set of positioning model IDs; an eighth set of cell IDs; a ninth set of location indicators; a tenth set of timing indicators; an indicator of a ranking for a set of positioning settings; an eleventh set of positioning model inputs and a twelfth set of positioning model outputs used on the positioning model; a thirteenth set of K-percentile positioning error statistics, or a fourteenth set of average positioning error calculations. In some aspects, the BW settings may include a number of physical resource blocks (RBs) or a MHz range. The set of TRP IDs may indicate which TRPs are recommended for transmitting/measuring positioning signals. The set of location indicators may include latitude, longitude, and/or elevation indicators for recommended transmitting/receiving wireless devices, or that correspond with a set of recommendations. The set of timing indicators may indicate a recommended time duration, a recommended start UTC, and/or a recommended stop UTC.

Aspect 6 is the method of aspect 5, wherein the ninth set of location indicators comprise at least one of: a thirteenth set of indicators associated with a fourteenth set of latitudes; a fifteenth set of indicators associated with a sixteenth set of longitudes; or a seventeenth set of indicators associated with an eighteenth set of elevations.

Aspect 7 is the method of either of aspects 5 or 6, further comprising selecting a thirteenth set of cells based on the ninth set of location indicators, wherein selecting the second set of positioning model settings based on the received first set of recommended positioning model statistics comprises selecting the second set of positioning model settings based on the selected thirteenth set of cells.

Aspect 8 is the method of any of aspects 1 to 7, further comprising transmitting a request message comprising an indicator of a request for the first set of recommended positioning model statistics before the reception of the first set of recommended positioning model statistics.

Aspect 9 is the method of aspect 8, further comprising receiving a capability message comprising a second indicator of a capability of a second wireless device to transmit the first set of recommended positioning model statistics, wherein the transmission of the request message is based on the capability of the second wireless device to transmit the first set of recommended positioning model statistics.

Aspect 10 is the method of aspect 9, further comprising transmitting a second request message comprising a third indicator of a second request for the capability message before the reception of the capability message.

Aspect 11 is the method of any of aspects 1 to 10, further comprising selecting the positioning model based on the received first set of recommended positioning model statistics.

Aspect 12 is the method of any of aspects 1 to 11, wherein selecting the second set of positioning model settings based on the received first set of recommended positioning model statistics comprises selecting a subset of the first set of recommended positioning model statistics based on a fifth set of measurement selection criteria.

Aspect 13 is the method of aspect 12, wherein the fifth set of measurement selection criteria comprises at least one of: a delay spread threshold range; a line-of-sight (LOS) peak width; a Rician factor; a number of transmission reception points (TRPs); or a TRP identifier (ID).

Aspect 14 is the method of any of aspects 1 to 13, wherein the wireless device comprises at least one of a user equipment (UE), a transmission reception point (TRP), or a base station.

Aspect 15 is a method of wireless communication at a wireless device, comprising: obtaining a plurality of sets of positioning model statistics; and transmitting a set of recommended positioning model statistics based on the obtained plurality of sets of positioning model statistics.

Aspect 16 is the method of aspect 15, wherein obtaining the plurality of sets of positioning model statistics comprises: obtaining a second plurality of sets of positioning signal measurements; calculating a third plurality of sets of positioning outputs using a positioning model based on the second plurality of sets of positioning signal measurements; obtaining a fourth plurality of sets of reliable positioning output data; and calculating the plurality of sets of positioning model statistics based on a comparison of the calculated third plurality of sets of positioning outputs against the fourth plurality of sets of reliable positioning output data.

Aspect 17 is the method of aspect 16, wherein obtaining the second plurality of sets of positioning signal measurements comprises: receiving a second set of positioning signals and a third set of positioning signals; and measuring the second set of positioning signals and the third set of positioning signals, wherein the second plurality of sets of positioning signal measurements comprises the measured second set of positioning signals and the measured third set of positioning signals.

Aspect 18 is the method of either of aspects 16 or 17, wherein obtaining the second plurality of sets of positioning signal measurements comprises receiving a second set of positioning signal measurements and a third set of positioning signal measurements, wherein the second plurality of sets of positioning signal measurements comprises the measured second set of positioning signals and the measured third set of positioning signals.

Aspect 19 is the method of any of aspects 16 to 18, wherein obtaining the fourth plurality of sets of reliable positioning output data comprises calculating a second set of reliable positioning output data based on a third set of positioning sensors, wherein the fourth plurality of sets of reliable positioning output data comprises the second set of reliable positioning output data.

Aspect 20 is the method of aspect 19, wherein the third set of positioning sensors comprise at least one of: a global navigation satellite system (GNSS) receiver; a global positioning satellite (GPS) receiver; an accelerometer; a light detection and ranging (LIDAR) sensor, or an internal measurement unit (IMU).

Aspect 21 is the method of any of aspects 16 to 20, wherein obtaining the fourth plurality of sets of reliable positioning output data comprises calculating a second set of reliable positioning output data based on a second positioning model, wherein the fourth plurality of sets of reliable positioning output data comprises the second set of reliable positioning output data. The second positioning model may be, for example, a legacy positioning model (e.g., a model that was not trained using AI/ML, but rather calculates a distance between two wireless devices based on an RTT). Such legacy models may be used to verify the accuracy of AI/ML positioning models, as well as to rate the reliability of a set of positioning model settings used with an AI/ML positioning model.

Aspect 22 is the method of any of aspects 16 to 21, wherein obtaining the fourth plurality of sets of reliable positioning output data comprises receiving a second set of reliable positioning output data, wherein the fourth plurality of sets of reliable positioning output data comprises the second set of reliable positioning output data. For example, a PDU with a known location may transmit its location, or broadcast its location, to help collect a set of statistics that may be used for positioning model setting recommendations. In other aspects, an admin user may directly enter a location of a positioning target wireless device for calculating such sets of statistics.

Aspect 23 is the method of any of aspects 16 to 22, wherein calculating the third plurality of sets of positioning outputs using the positioning model based on the second plurality of sets of positioning signal measurements comprises: selecting a subset of the second plurality of sets of positioning signal measurements based on measurement selection criteria; and calculating the third plurality of sets of positioning outputs using the positioning model based on the selected subset of the second plurality of sets of positioning signal measurements.

Aspect 24 is the method of aspect 23, wherein the measurement selection criteria comprises at least one of: a delay spread threshold range; a line-of-sight (LOS) peak width; a Rician factor; a number of transmission reception points (TRPs); or a TRP identifier (ID).

Aspect 25 is the method of any of aspects 16 to 24, wherein the calculated third plurality of sets of positioning outputs comprise at least one of: a location of a user equipment (UE); a line-of-sight (LOS) identification metric; timing measurement; or an angle measurement.

Aspect 26 is the method of any of aspects 15 to 25, wherein obtaining the plurality of sets of positioning model statistics comprises receiving a second set of positioning model statistics and a third set of positioning model statistics, wherein the plurality of sets of positioning model statistics comprises the second set of positioning model statistics and the third set of positioning model statistics. In other words, a network entity, for example an LMF, may aggregate sets of positioning model statistics from a plurality of testing occasions and/or from a plurality of wireless devices to use for recommended settings.

Aspect 27 is the method of aspect 26, further comprising selecting the set of recommended positioning model statistics from the plurality of sets of positioning model statistics based on a fourth set of positioning error criteria.

Aspect 28 is the method of aspect 27, wherein the fourth set of positioning error criteria comprise at least one of: a positioning error percentile; an average positioning error range; a positioning error range; a number of positioning occasions; or a recommendation ranking. A positioning occasion may also be referred to as a trial.

Aspect 29 is the method of any of aspects 15 to 28, wherein the plurality of sets of positioning model statistics comprise at least one of: a first indicator of a positioning error percentile; a second indicator of an average positioning error; a third indicator of a positioning error range; or a number of positioning occasions.

Aspect 30 is the method of any of aspects 15 to 29, wherein the wireless device comprises at least one of a user equipment (UE), a transmission reception point (TRP), a base station, or a location management function (LMF).

Aspect 31 is an apparatus for wireless communication, comprising: at least one memory; and at least one processor coupled to the at least one memory and, based at least in part on information stored in the at least one memory, the at least one processor, individually or in any combination, is configured to perform the method of any of aspects 1 to 30.

Aspect 32 is an apparatus for wireless communication, comprising means for performing each step in the method of any of aspects 1 to 30.

Aspect 33 is the apparatus of any of aspects 1 to 30, further comprising a transceiver (e.g., functionally connected to the at least one processor of aspect 31) configured to receive or to transmit in association with the method of any of aspects 1 to 30.

Aspect 34 is a computer-readable medium (e.g., a non-transitory computer-readable medium) storing computer executable code, the code when executed by at least one processor causes the at least one processor, individually or in any combination, to perform the method of any of aspects 1 to 30.

What is claimed is:

1. An apparatus for wireless communication at a wireless device, comprising:
at least one memory; and
at least one processor coupled to the at least one memory and, based at least in part on information stored in the at least one memory, the at least one processor, individually or in any combination, is configured to:
receive a first set of recommended positioning model statistics;
select a second set of positioning model settings based on the received first set of recommended positioning model statistics;
receive a third set of positioning signals;
measure the third set of positioning signals based on the selected second set of positioning model settings; and
calculate a fourth set of positioning outputs using a positioning model based on the measured third set of positioning signals and the selected second set of positioning model settings.

2. The apparatus of claim 1, wherein the at least one processor, individually or in any combination, is further configured to:
transmit a positioning report comprising an indicator of the calculated fourth set of positioning outputs.

3. The apparatus of claim 1, wherein the at least one processor, individually or in any combination, is further configured to:
calculate a position of a user equipment (UE) based on the calculated fourth set of positioning outputs.

4. The apparatus of claim 3, wherein the at least one processor, individually or in any combination, is further configured to:
transmit a positioning report comprising an indicator of the calculated position of the UE.

5. The apparatus of claim 1, wherein the at least one processor, individually or in any combination, is further configured to:
transmit a request message comprising an indicator of a request for the first set of recommended positioning model statistics before the reception of the first set of recommended positioning model statistics.

6. The apparatus of claim 5, wherein the at least one processor, individually or in any combination, is further configured to:
receive a capability message comprising a second indicator of a capability of a second wireless device to transmit the first set of recommended positioning model statistics, wherein the transmission of the request message is based on the capability of the second wireless device to transmit the first set of recommended positioning model statistics.

7. The apparatus of claim 6, further comprising a transceiver coupled to the at least one processor, wherein the at least one processor, individually or in any combination, is further configured to:
transmit, via the transceiver, a second request message comprising a third indicator of a second request for the capability message before the reception of the capability message.

8. The apparatus of claim 1, wherein the at least one processor, individually or in any combination, is further configured to:
select the positioning model based on the received first set of recommended positioning model statistics.

9. The apparatus of claim 1, wherein, to select the second set of positioning model settings based on the received first set of recommended positioning model statistics, the at least one processor, individually or in any combination, is configured to:
select a subset of the first set of recommended positioning model statistics based on a fifth set of measurement selection criteria.

10. An apparatus for wireless communication at a wireless device, comprising:
at least one memory; and
at least one processor coupled to the at least one memory and, based at least in part on information stored in the at least one memory, the at least one processor, individually or in any combination, is configured to:
obtain a plurality of sets of positioning model statistics; and
transmit a set of recommended positioning model statistics based on the obtained plurality of sets of positioning model statistics.

11. The apparatus of claim 10, wherein, to obtain the plurality of sets of positioning model statistics, the at least one processor, individually or in any combination, is configured to:
obtain a second plurality of sets of positioning signal measurements;
calculate a third plurality of sets of positioning outputs using a positioning model based on the second plurality of sets of positioning signal measurements;
obtain a fourth plurality of sets of reliable positioning output data; and
calculate the plurality of sets of positioning model statistics based on a comparison of the calculated third plurality of sets of positioning outputs against the fourth plurality of sets of reliable positioning output data.

12. The apparatus of claim 11, wherein, to obtain the second plurality of sets of positioning signal measurements, the at least one processor, individually or in any combination, is configured to:
receive a second set of positioning signals and a third set of positioning signals; and
measure the second set of positioning signals and the third set of positioning signals, wherein the second plurality of sets of positioning signal measurements comprises the measured second set of positioning signals and the measured third set of positioning signals.

13. The apparatus of claim 11, wherein, to obtain the second plurality of sets of positioning signal measurements, the at least one processor, individually or in any combination, is configured to:
receive a second set of positioning signal measurements and a third set of positioning signal measurements, wherein the second plurality of sets of positioning signal measurements comprises the measured second set of positioning signals and the measured third set of positioning signals.

14. The apparatus of claim 11, wherein, to obtain the fourth plurality of sets of reliable positioning output data, the at least one processor, individually or in any combination, is configured to:
calculate a second set of reliable positioning output data based on a third set of positioning sensors, wherein the fourth plurality of sets of reliable positioning output data comprises the second set of reliable positioning output data.

15. The apparatus of claim 11, wherein, to obtain the fourth plurality of sets of reliable positioning output data, the at least one processor, individually or in any combination, is configured to:
calculate a second set of reliable positioning output data based on a second positioning model, wherein the fourth plurality of sets of reliable positioning output data comprises the second set of reliable positioning output data.

16. The apparatus of claim 11, wherein, to obtain the fourth plurality of sets of reliable positioning output data, the at least one processor, individually or in any combination, is configured to:
receive a second set of reliable positioning output data, wherein the fourth plurality of sets of reliable positioning output data comprises the second set of reliable positioning output data.

17. The apparatus of claim 11, wherein, to calculate the third plurality of sets of positioning outputs using the positioning model based on the second plurality of sets of positioning signal measurements, the at least one processor, individually or in any combination, is configured to:
select a subset of the second plurality of sets of positioning signal measurements based on measurement selection criteria; and
calculate the third plurality of sets of positioning outputs using the positioning model based on the selected subset of the second plurality of sets of positioning signal measurements.

18. The apparatus of claim 10, further comprising a transceiver coupled to the at least one processor, wherein, to obtain the plurality of sets of positioning model statistics, the at least one processor, individually or in any combination, is configured to:
receive, via the transceiver, a second set of positioning model statistics and a third set of positioning model statistics, wherein the plurality of sets of positioning model statistics comprises the second set of positioning model statistics and the third set of positioning model statistics.

19. The apparatus of claim 18, wherein the at least one processor, individually or in any combination, is further configured to:
select the set of recommended positioning model statistics from the plurality of sets of positioning model statistics based on a fourth set of positioning error criteria.

20. A method of wireless communication at a wireless device, comprising:
receiving a first set of recommended positioning model statistics;
selecting a second set of positioning model settings based on the received first set of recommended positioning model statistics;
receiving a third set of positioning signals;
measuring the third set of positioning signals based on the selected second set of positioning model settings; and
calculating a fourth set of positioning outputs using a positioning model based on the measured third set of positioning signals and the selected second set of positioning model settings.
